(19) United States
(12) Patent Application Publication
(10) Pub. No.: US 2019/0180301 A1
(43) Pub. Date: Jun. 13, 2019

(54) SYSTEM FOR CAPTURING ITEM DEMAND TRANSFERENCE

(71) Applicant: Walmart Apollo, LLC, Bentonville, AR (US)

(72) Inventors: Omker Mahalanobish, Kolkata (IN); Subhasish Misra, Bangalore (IN); Amlan Jyoti Das, Bangalore (IN); Souraj Mishra, Bangalore (IN)

(21) Appl. No.: 15/877,388

(22) Filed: Jan. 23, 2018

(30) Foreign Application Priority Data
Dec. 9, 2017 (IN) 201741044276

(51) Int. Cl. G06Q 30/02; G06Q 10/08; H04W 4/35

(52) U.S. Cl. CPC G06Q 30/0206; H04W 4/35; G06Q 10/087

(57) ABSTRACT

Examples provide demand transference modeling for item assortment management. A demand prediction component analyzes item attribute data using a demand transference model to calculate a magnitude of demand transfer between items in a set of substitute items associated with a proposed item assortment. The proposed item assortment includes at least one assortment change. The assortment change includes a set of one or more items to be added to a current item assortment and/or a set of one or more items to be removed from the current item assortment. The demand prediction component generates a demand transference result including the calculated magnitude of demand transfer for each item in the set of substitute items and/or a predicted walk-off rate associated with lost demand. An assortment recommendation component generates an accept recommendation and/or a reject recommendation based on the demand transference result, the predicted walk-off rate, and/or a demand transference score.

### BACKGROUND

An item assortment is the combination of items available at a given time for a store. It is desirable to create an item assortment that provides the set of items most likely to attract users to the store and maximize transactions associated with items in the assortment. However, assortments cannot remain stagnant over time. As items experience a decline in demand over time, it is frequently beneficial to remove these lower performance items to make space for additional new items which may attract greater interest and demand.

Currently, items are typically added and removed from item assortments based on actual number of transactions or sales with little or no consideration given to incremental demand or lack of available substitutes for removed items. This frequently leads to improper assortment decisions.

### SUMMARY

Examples of the disclosure provide a system for demand transference modeling. The system includes a memory, at least one processor communicatively coupled to the memory; and a plurality of sensor devices associated with a retail environment. An item selection component analyzes item attribute data for each item in the plurality of items, transaction data associated with the plurality of items during a predetermined time-period, and sensor data generated by the plurality of sensor devices. The item selection component identifies a set of substitute items for a proposed item assortment based on the analysis. The proposed item assortment includes a proposed removal of an identified item from a current item assortment for the retail environment. A demand transference modeling component calculates a transference of demand between each item in the identified set of substitute items predicted to occur in response to the proposed removal of the identified item. The transference of demand includes a transfer of at least a portion of demand from the identified item to one or more substitute items in the set of substitute items. The transference of demand also includes a predicted walk-off rate associated with lost demand attributable to removal of the identified item. A results component generates a per-assortment demand transference result customized for the retail environment and the proposed item assortment based on the calculated demand transference. The results component outputs the per-assortment demand transference result via a user interface component. The per-assortment demand transference result includes an identification of each item in the set of substitute items predicted to receive at any portion of the demand transferred from the identified item and a magnitude of demand transferred to each item.

Other examples provide a computer-implemented method for demand transference modeling. A demand prediction component receives a proposed item assortment associated with a retail environment, the proposed item assortment includes a set of items to be added to inventory and a set of items to be removed from inventory. A demand prediction component calculates a demand transference between substitute items in a plurality of items associated with the proposed item assortment based on an analysis of transaction data associated with the retail environment, attribute data associated with the plurality of items, and assortment history data. A demand transference result score customized for the proposed item assortment is generated based on the calculated demand transference by the demand prediction component. The transference result score includes an identification of each substitute item in the plurality of items predicted to experience an increase or decrease in demand due to an assortment change associated with the proposed item assortment and a magnitude of predicted demand change associated with each identified item.

Still other examples provide a system for demand transference modeling between substitute items in an item assortment. The system includes a memory and at least one processor communicatively coupled to the memory. A demand transference modeling component receives a proposed item assortment including a change to a current item assortment associated with a retail environment. The demand transference modeling component calculates a demand transference between a set of substitute items within the proposed item assortment due to the change. The change includes a proposed addition of a selected new item to a plurality of items available within the retail environment. A results component generates a predicted demand transference result customized for the proposed item assortment. The demand transference result is generated based on the calculated demand transference. The demand transference result includes an identification of each item in the set of items predicted to experience a change in demand due to addition of the selected new item to a current item assortment and a magnitude of the demand change associated with each item in the set of items. An assortment recommendation component outputs a recommendation to implement the proposed item assortment on condition the demand transference result indicates creation of new demand associated with the addition of the selected new item and predicted horizontal demand transference away from one or more legacy items to the selected new item is within an acceptable threshold range.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for capturing item demand transference.

FIG. 2 is an exemplary block diagram illustrating a proposed item assortment.

FIG. 3 is an exemplary block diagram illustrating a set of proposed item assortments.

FIG. 4 is an exemplary block diagram illustrating per-item demand change due to an assortment change.

FIG. 5 is an exemplary block diagram illustrating transference of demand identified by a demand prediction component for a suggested removal of an item from a current item assortment.

FIG. 6 is an exemplary block diagram illustrating a demand prediction component for generating a per-assortment demand transference result.

FIG. 7 is an exemplary block diagram illustrating a demand transference result generated by a results component.

FIG. 8 is an exemplary block diagram illustrating an assortment recommendation generated by an assortment recommendation component.

FIG. 9 is an exemplary graph illustrating demand for a set of substitute items.

FIG. 10 is an exemplary graph illustrating incremental demand for a set of substitute items.

FIG. 11 is an exemplary graph illustrating demand transference between substitute items.

FIG. 12 is another exemplary graph illustrating demand transference between substitute items.

FIG. 13 is an exemplary flow chart illustrating operation of the computing device to generate a demand transference result.

FIG. 14 is an exemplary flow chart illustrating operation of the computing device to generate a demand transference score.

FIG. 15 is an exemplary flow chart illustrating operation of the computing device to generate an item similarity score.

FIG. 16 is an exemplary flow chart illustrating operation of the computing device to generate a new per-assortment demand transference score.

FIG. 17 is an exemplary table including scanner data generated by a plurality of sensors associated with a plurality of items within a retail environment.

FIG. 18 is an exemplary table including attribute data for a set of substitute items.

FIG. 19 is an exemplary table including a set of similarity scores for a first substitute item with respect to a second substitute item generated on a weekly basis.

FIG. 20 is an exemplary table including a weekly weight proximity data for each item in a set of substitute items.

FIG. 21 is an exemplary table including a weekly weight similarity score for an identified item.

Corresponding reference characters indicate corresponding parts throughout the drawings.

### DETAILED DESCRIPTION

Referring to the figures, some examples of the disclosure enable capturing demand transference due to assortment changes on a per-store level. In some examples, a demand prediction component generates a demand transference result which quantifies a magnitude of demand transferred to each item in a given item assortment based on the unique combination of items in the assortment. The demand transference result more accurately predicts the amount of demand which is transferred away from each item, transferred to each item, created by each item, and/or lost as a result of the assortment change. This improves assortment optimization and more accurately predicts creation or loss of demand prior to adding or deleting items from actual inventory for improved user satisfaction and optimization of item assortment creation.

Other examples provide a demand transference model which analyzes item-related data to predict a magnitude of demand transferred between items in response to proposed assortment changes. The demand transference model in some examples captures the essence of demand transference using only point-of-sale (POS) and attribute data. This enables quantification of the magnitude of item-wise demand transfer and extend of walk-off without implementing changes to the store inventory.

Other examples provide an assortment recommendation component which analyzes one or more proposed item assortments and recommends acceptance or rejection of assortment based on predicted magnitude of horizontal item transfer between substitute items and/or prediction of incremental demand associated with items to be added or removed from each unique proposed assortment. Incremental demand refers to demand associated with a given item that fails to transfer to other items when the item is removed from the assortment (lost demand). Incremental demand also includes the new demand created by adding an item to an assortment.

This assortment recommendation component in some examples outputs a demand transference score with the recommendation. This score ranks each proposed assortment relative to one or more other assortments. This enables a user to more accurately accept or reject various assortments along and identify which assortment(s) provide the most desirable demand transference and/or new demand creation.

This demand prediction component in other examples optimizes analysis of various potential assortments and outputs identification of assortments having the optimum score and/or levels of demand associated with items in each assortment while minimizing negative effects, such as lost incremental demand, due to implementation of assortment changes.

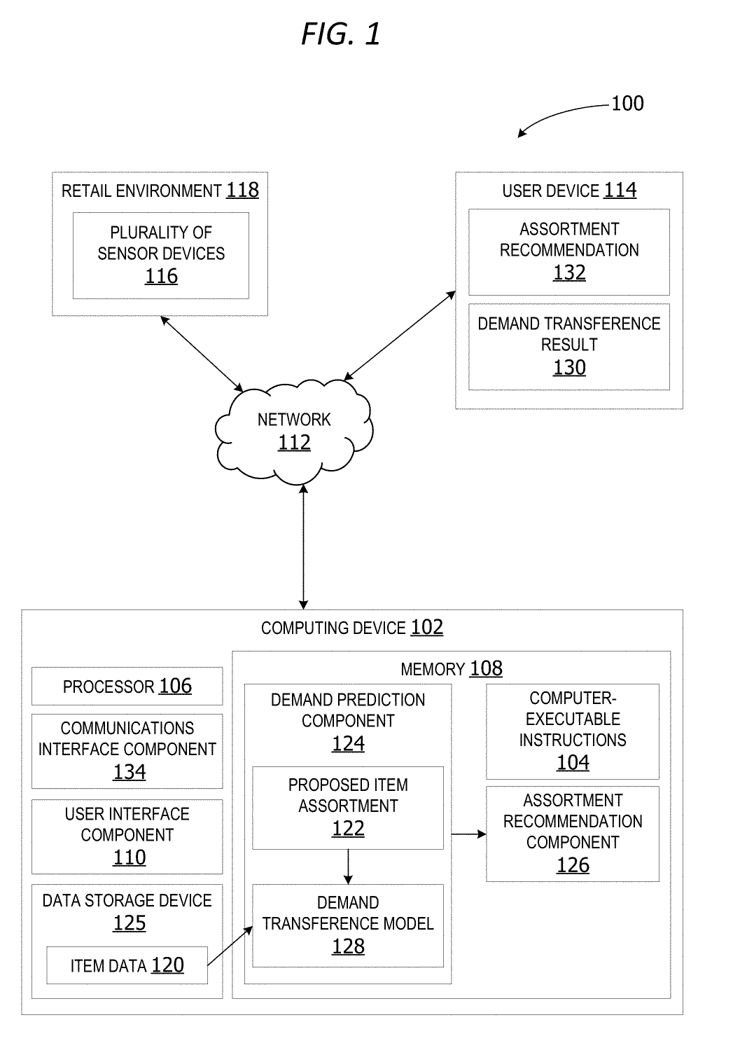

Referring again to FIG. 1, an exemplary block diagram illustrates a system 100 for capturing demand transfer between items. While an item substitution measure provides for the direction of demand, demand transference quantifies the magnitude of the demand that may get transferred to a specific item when its substitute is deleted. Demand transference also quantifies magnitude of demand transferred to a new item when the new item is introduced in a store and cannibalizes on similar items.

In the example of FIG. 1, the computing device 102 represents any device executing computer-executable instructions 104 (e.g., as application programs, operating system functionality, or both) to implement the operations and functionality associated with the computing device 102. The computing device 102 may include a mobile computing device or any other portable device. In some examples, the mobile computing device includes a mobile telephone, laptop, tablet, computing pad, netbook, gaming device, and/or portable media player. The computing device 102 may also include less portable devices such as desktop personal computers, kiosks, tabletop devices, industrial control devices, wireless charging stations, and electric automobile charging stations. Additionally, the computing device 102 may represent a group of processing units or other computing devices.

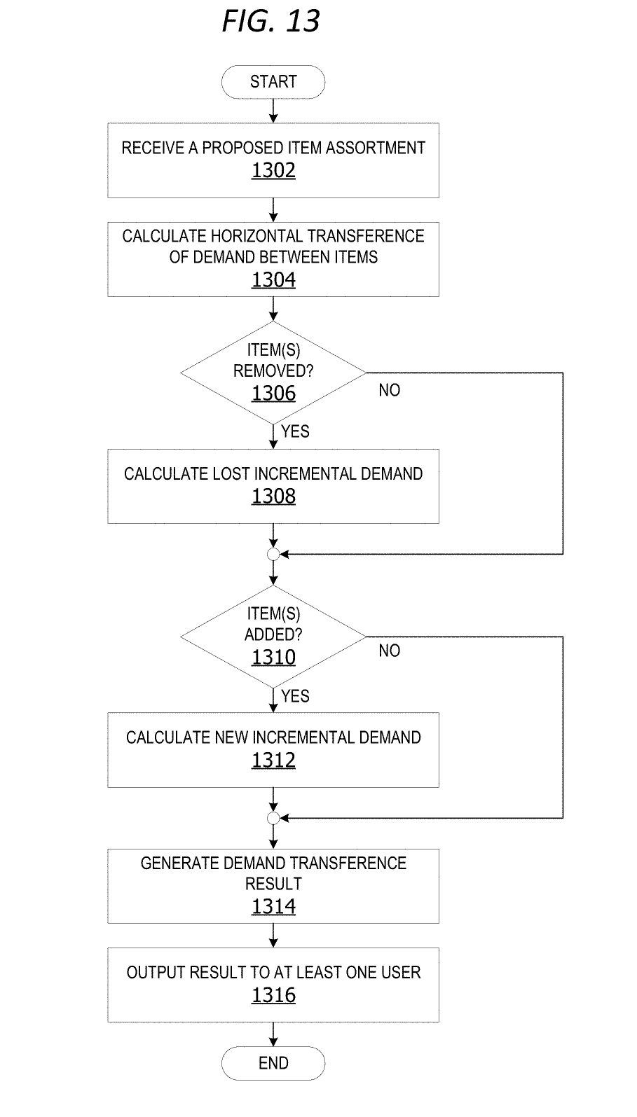

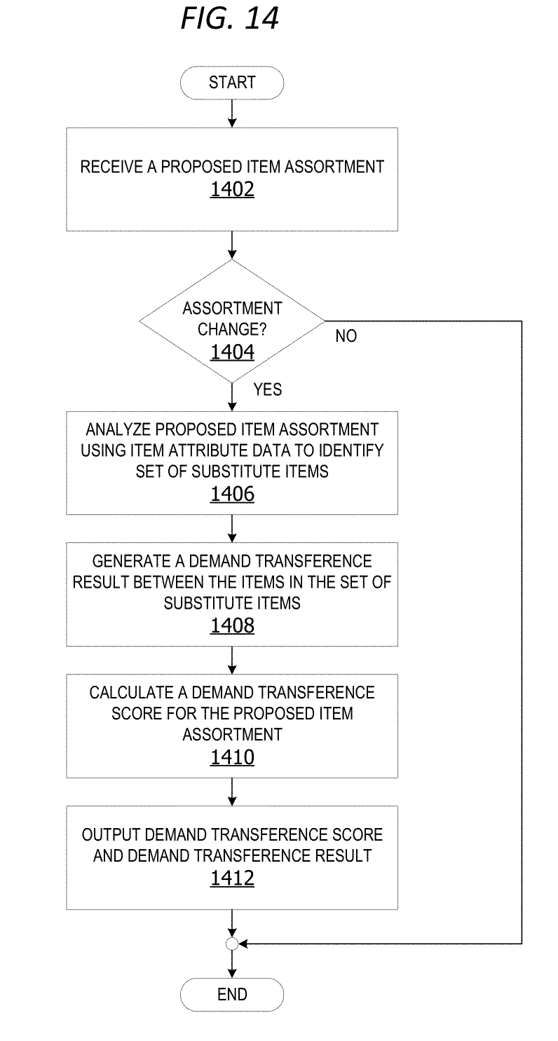

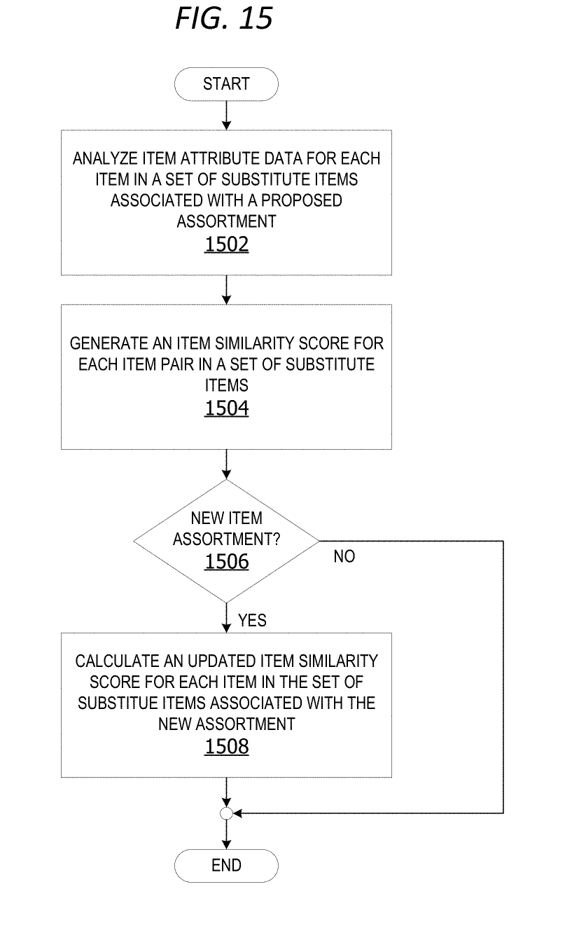

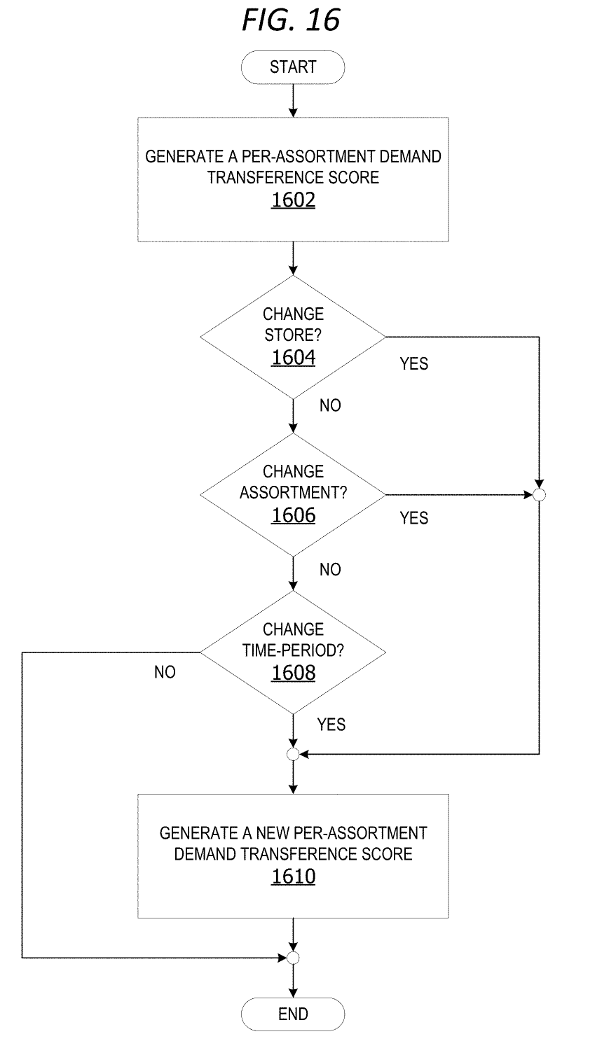

In some examples, the computing device 102 has at least one processor 106, a memory 108, and at least one user interface component 110. The processor 106 includes any quantity of processing units, and is programmed to execute computer-executable instructions 104. The instructions may be performed by the processor 106 or by multiple processors within the computing device 102, or performed by a processor external to the computing device 102. In some examples, the processor 106 is programmed to execute instructions such as those illustrated in the figures (e.g., FIG. 13, FIG. 14, FIG. 15, and FIG. 16).

The computing device 102 further has one or more computer readable media such as the memory 108. The memory includes any quantity of media associated with or accessible by the computing device 102. The memory 108 may be internal to the computing device 102 (as shown in FIG. 1), external to the computing device (not shown), or both (not shown). In some examples, the memory 108 includes read-only memory and/or memory wired into an analog computing device.

The memory 108 stores data, such as, but not limited to, one or more applications. The applications, when executed by the processor, operate to perform functionality on the computing device 102. The applications may optionally communicate with counterpart applications or services such as web services accessible via a network 112. For example, the applications may represent downloaded client-side applications that correspond to server-side services executing in a cloud.

The network 112 is implemented by one or more physical network components, such as, but without limitation, routers, switches, network interface cards (NICs), and other network devices. The network 112 may be any type of network for enabling communications with remote computing devices, such as, but not limited to, a local area network (LAN), a subnet, a wide area network (WAN), a wireless (Wi-Fi) network, or any other type of network. In this example, the network is a WAN, such as the Internet. However, in other examples, the network may be a local or private LAN.

The network 112 optionally enables communications with remote devices, such as, but not limited to, a user device 114 and/or a plurality of sensor devices 116 associated with a retail environment 118. The retail environment is a location including a plurality of items associated with one or more shelfs or displays available for purchase by customers. The retail environment may include an interior of a store, an exterior of a store, as well as both an interior area and an exterior area of a store.

The user device 114 includes any type of computing device associated with one or more users, such as, but not limited to, a mobile computing device or other portable device. In some examples, the user device 114 is implemented as a mobile telephone, laptop, tablet, wearable computing device, or other portable device. In other examples, the user device 114 may also include less portable devices, such as desktop personal computers, kiosks, and/or tabletop devices.

The plurality of sensor devices 116 includes one or more sensor devices within a retail environment for gathering item data 120, transaction data, and/or assortment data associated with one or more items included within a proposed item assortment 122.

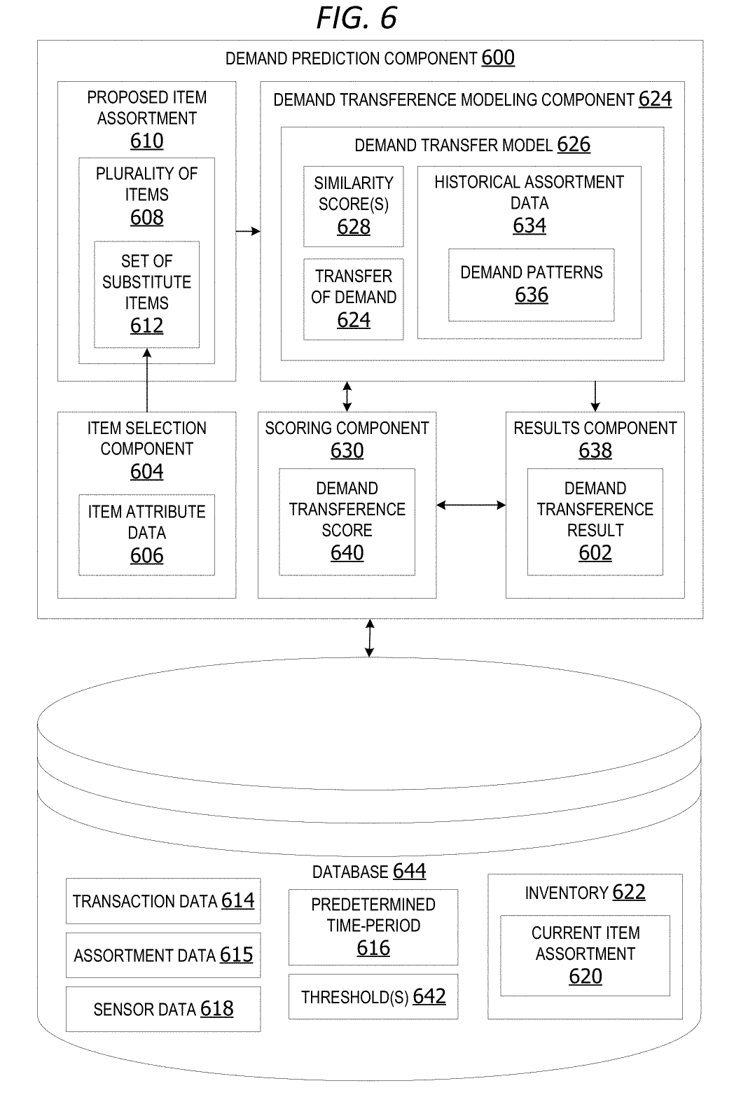

The item data 120 is data associated with one or more items in the proposed item assortment. The item data 120 includes item attribute data describing one or more attributes of each item in the proposed item assortment 122. The transaction data includes data associated with sales of items, such as the transaction data 614 in FIG. 6. The assortment data is data describing the proposed item assortment 122, such as the assortment data 615 in FIG. 6. The assortment data may include data associated with a proposed item assoi linent, a current item assortment, and/or an historical item assortment used in the past.

The proposed item assortment 122 is a suggested assortment of items to be included within an inventory of the retail environment 118. The proposed item assortment 122 includes a set of one or more items to be added to the inventory and/or a set of one or more items to be removed from the inventory.

The plurality of sensor devices 116 may include one or more image capture devices, one or more scanners, one or more pressure sensors, one or more light sensors, one or more proximity sensors, one or more microphones, as well as any other type of sensor devices. A scan may include a radio frequency identifier (RFID) tag reader, a barcode reader, an optical character recognition (OCR) scanner, or any other type of scanner. A barcode reader may include a matrix barcode reader, a universal product code (UPC) reader, or any other type of barcode reader. A scanner may include a handheld scanner, a stationary scanner mounted on a ceiling, shelf, wall or other structure. A scanner device may also include a mobile robotic scanner device or any other type of scanner device.

The plurality of sensor devices 116 generate sensor data associated with one or more items available within the retail environment 118. The sensor data in some examples is stored on a data storage device 125.

The data storage device 125 optionally includes a set of one or more data storage devices storing data, such as the item data 120, sensor data, transaction data, item assortment data, or any other. The data storage device may include one or more types of data storage devices, such as, for example, one or more rotating disks drives, one or more solid state drives (SSDs), and/or any other type of data storage device. The data storage device 125 in some non-limiting examples includes a redundant array of independent disks (RAID) array. In other examples, the data storage device 125 includes a database.

The memory 108 stores one or more computer-executable components. Exemplary components include a demand prediction component 124 and/or an assortment recommendation component 126. The demand prediction component 124, when executed by the processor 106 of the computing device 102, causes the processor 106 to receive and analyze the proposed item assortment 122 associated with the retail environment 118. The demand prediction component 124 analyzes the item data 120 with transaction data and/or assortment history data associated with the retail environment 118 using a demand transference model 128.

When an item is dropped from a current item assortment, part of the demand associated with that item is transferred to other similar items and part of the demand may be lost due to item loyalty. Likewise, when a new item is added to an assortment for a store, the item generates some new demand due it its unique attributes (incremental demand) but the item may also cannibalize demand away from other similar items in the assortment. Therefore, an incorrect choice of item for deletion from an assortment may lead to lost sales due to unavailability of suitable substitutes, customer dissatisfaction, and churning of customer base. Likewise, improper choice of new items for addition to an assortment may result in inadequate creation of new demand and reduced demand for other items due new items cannibalizing the demand of the other items in the assortment.

Therefore, the demand prediction component 124 calculates an amount of demand transfer between substitute items in a plurality of items associated with the proposed item assortment 122 prior to implementation of the assortment change. In this manner, the demand prediction component 124 identifies potentially negative demand transfers likely to occur in response to alterations to an existing assortment.

The demand prediction component 124 in some examples calculates the demand transference using the demand transference model 128 analysis results. The demand prediction component 124 generates a demand transference result 130 customized for the proposed item assortment based on the calculated demand transference.

In some examples, the demand transference model 128 includes one or more regression models (in a longitudinal setup) used to estimate demand for an item. Among other explanatory variables, the demand transference model 128 includes a negative horizontal transference variable that accounts for cannibalization effect of similar items. The cannibalization variable of the demand transference model 128 in some examples uses the attribute data to calculate item similarity. Its value changes depending on presence or absence of similar items. The cannibalization variable is the instrument through which demand transference seeps into the model.

The demand prediction component 124 in some examples receives inputs including POS data shown in unit sales (number of units sold) and dollar sales (total dollars for sales) customized for an identified item at a specific store or location during a predetermined time-period. For example, the POS data may be generated for a given item at a given store on a weekly basis (Store×Week×Item ID level).

The demand prediction component 124 in other examples receives input attribute data for each item in a set of substitute items for a given assortment. In one example, the attribute data includes attributes such as item brand, item size, item price-per-unit, or any other attribute. The attribute in one example includes attributes of each item UPC in each category.

A category may be divided into mutually exclusive and exhaustive groups of items, called substitutable groups. A category may include, for example, a food category and a general merchandise category. A substitutable group consists of items that are more likely to be substitutes of each other, than that of items in the other substitutable groups. A substitutable group may also be referred to as a set of substitute items. For example, but without limitation, a substitutable group or set of substitute items may be a bread group including white bread, wheat bread, and whole wheat bread.

In some examples, the demand prediction component 124 performs segmentation into one or more substitutable groups by using a proprietary graph partition based algorithm. When, implemented for a substitutable group, the demand prediction component 124 restricts the transfer of demand within the same group; since by definition, there is very less probability of items in other groups to be proper substitutes.

Inventory data may also be provided as input to the demand prediction component 124. The inventory data includes item inventory at a given store or retail location for a predetermined time-period. For example, inventory data may include item availability at a given store on a weekly basis (Store×Week×UPC level).

Other inputs provided to the demand prediction component 124 may include historical assortment data, such as the historical assortment data 634 shown in FIG. 6 below. The historical assortment data may include assortment change information at a store level and/or at a national level.

The demand prediction component 124 in other examples automatically accounts for complications such as multicollinearity and sundry, regression violations by forecasting the manner in which addition or removal of one item affects demand associated with other similar items in the same assortment over a predetermined time-period. Because each store is unique in terms of the consumer demand pattern these models have been estimated at a store×substitutable community level. This means that for a category with ten or more substitute items in a set of substitute items for a given assortment, the model estimates ten times four thousand (10*4000) or more variables, which equals forty-thousand or more models using parallelization techniques in Hadoop.

These models predict the extent of transference via simulations using predicted magnitudes of demand transference on a per-item basis for a given assortment of items within a specified store during a predetermined time-period. For example, if an item “i₁” in the pre-delete scenario prior to item removal is selling one-hundred units per predetermined time-period, then the demand transference model determines how many units of the deleted item demand is transferred to each substitute item for the removed item, such as item “i₂”, item “i₃”, and item “i₄”. This is calculated by the model at an individual store level as well as at a location, region, county, state, country, or other level.

The demand prediction component 124 in some examples outputs a magnitude of sales for each item in a given assortment. For example, the demand transference model 128 may output predicted per-unit sales at a given store on a weekly basis (Store×Week×UPC level) if one or more proposed assortment changes are implemented. The demand prediction component 124 in other examples may output an estimated walk-off rate (demand lost) for the proposed assortment changes.

In still other examples, the demand prediction component 124 utilizes a multinomial logic model to estimate how sales of a given item are affected by price and presence of one or more item attributes. The demand prediction component 124 utilizes item attributes and historical transaction data to generate the predicted demand transference. In one example, the historical transaction data includes historical sales for a given item at a given store during a predetermined time-period. For example, the historical transaction may include data for an identified item at an identified store or location within a given item assortment on a weekly basis (item×store×week×assortment). This ensures statistically robust models are generated.

The demand transference result 130 in some examples includes an identification of each substitute item in the plurality of items predicted to experience an increase or decrease in demand due to an assortment change associated with the proposed item assortment and a magnitude of predicted demand change associated with each identified item. In other examples, the demand transference result 130 includes a demand transference score ranking a magnitude of demand transference between substitute items.

The assortment recommendation component 126, when executed by the processor 106 of the computing device 102, causes the processor 106 to analyze the demand transference result 130 and generate an assortment recommendation 132. The assortment recommendation 132 may include a recommendation to accept or implement the proposed item assortment 122 or a recommendation to reject the proposed item assortment 122. In this manner, the assortment recommendation component 126 identifies improper assortment changes prior to the assortment changes being implemented in a store.

Thus, the assortment recommendation component in some examples identifies improper proposed assortments based on magnitude of demand transfer between items in the assortment without implementing the changes. Likewise, the assortment recommendation component 126 identifies assortments that maximize demand associated with items in the assortment to increase customer satisfaction and sales, while minimizing lost incremental demand.

The assortment recommendation component 126 in some examples, outputs the assortment recommendation 132 to the user via the user interface component 110. In other examples, the assortment recommendation component 126 outputs the assortment recommendation 132 to the user device 114 via the network 112. The assortment recommendation 132 may include the demand transference result with the recommendation.

In some examples, the system 100 optionally includes a communications interface component 134. The communications interface component 134 includes a network interface card and/or computer-executable instructions (e.g., a driver) for operating the network interface card. Communication between the computing device 102 and other devices may occur using any protocol or mechanism over any wired or wireless connection. In some examples, the communications interface component 134 is operable with short range communication technologies such as by using near-field communication (NFC) tags.

In some examples, the user interface component 110 includes a graphics card for displaying data to one or more users and/or receiving data from the one or more users. The user interface component 110 may also include computer-executable instructions (e.g., a driver) for operating the graphics card. Further, the user interface component 110 may include a display (e.g., a touch screen display or natural user interface) and/or computer-executable instructions (e.g., a driver) for operating the display. The user interface component 110 may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device 102 in a particular way.

In this example, the system 100 includes the network 112 connecting the computing device 102 with one or more remote computing devices and/or sensor devices, such as the user device 114. However, in other examples, the system 100 may be implemented in an absence of the network 112. In these examples, the computing device 102 outputs the demand prediction result(s) and/or assortment recommendation(s) via the user interface component 110.

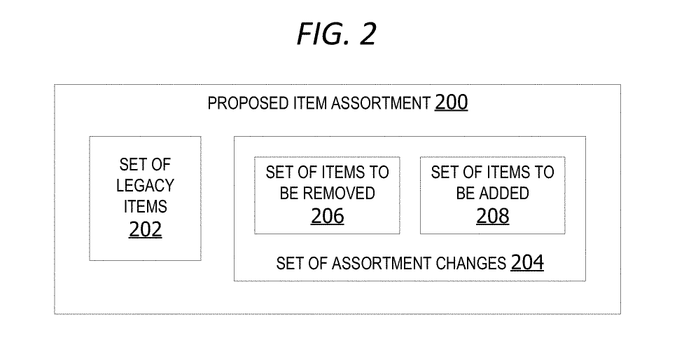

FIG. 2 is an exemplary block diagram illustrating a proposed item assortment 200. The proposed item assortment 200 includes a set of legacy items 202, and a set of assortment changes 204. The set of assortment changes 204 includes a set of items to be removed 206 and/or a set of new items to be added 208. The set of legacy items 202 is a set of one or more items that are included in a current item assortment and included in the new, proposed item assortment 200. In other words, legacy items are pre-existing items in a current assortment retained in accordance with the proposed item assortment 200.

The set of items to be removed 206 is a set of one or more items to be removed from the current item assortment. In other words, items in the set of items to be removed 206 are excluded from the proposed item assortment 200.

The set of new items to be added 208 is a set of one or more items which are currently absent from the current item assortment. The set of new items to be added 208 are items which are to be added to inventory in accordance with the proposed item assortment 200.

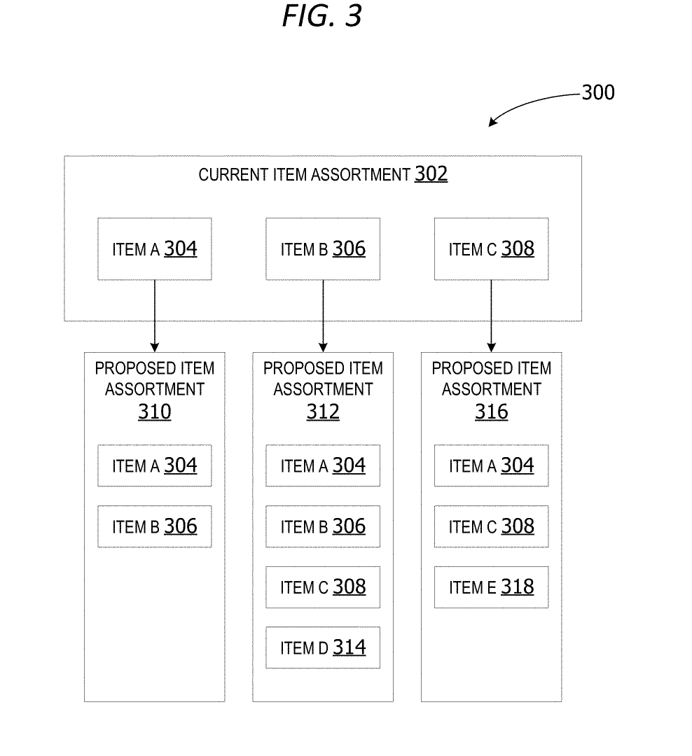

FIG. 3 is an exemplary block diagram illustrating a set of proposed item assortments 300. A current item assortment 302 is an assortment of items currently available for a particular retail environment or retail store. In this non-limiting example, the current item assortment 302 includes an item “A” 304, an item “B” 306, and an item “C” 308. Each item 304, 306, and 308 may represent any type of item, such as food items, hardware items, pet supply items, utensils, cookware, clothing items, etc.

In one non-limiting example, the current item assortment 302 may include condiments, such as ketchup. Item 304 may include a standard size bottle of ketchup, item 306 may be a larger-than-standard size bottle of ketchup, and item 308 may be a standard size bottle of organic ketchup. These items are substitute items because they have one or more attributes in common. In this example, these items are all condiments of a same or similar type.

A proposed item assortment includes one or more assortment changes. An assortment change is a change which adds one or more new items to the current item assortment 302 and/or removes one or more items from the current item assortment 302. In a given store and for a given set of substitute items, an assortment change may occur when one or more items are dropped from the current item assortment. Customers that intended to obtain any of the dropped items, may either choose to opt for another ‘substitutable’ item or walk away from the store without selecting a substitute item. When one or more items are introduced into the assortment, users that select one or more of the new items may choose the new item in addition to legacy items they typically select. However, if a user selects a new item instead of a legacy item they would have selected prior to addition of the new item, this is cannibalized demand taken from a legacy item and transferred to a new item. The cannibalized demand may be identified as negative or un-desirable demand transfer between items.

In this example, proposed item assortment 310 proposes to remove item 308 from the item assortment. Removal of item 308 may result in transferred demand from item 308 to item 304 and item 306. It may also result in lost demand due to walk-off.

The proposed item assortment 312 adds a new item “D” 314 to the current item assortment 302. The addition of item 314 may result in new incremental demand created by addition of item 314. It may also result in cannibalized demand transferred away from items 304, 306, and 308 to the new item 314.

In still another example, proposed item assortment 316 both removes item 306 from the current item assortment 302 and adds a new item “E” 318 to the current item assortment 302. In this example, demand transference may include creation of new incremental demand for item 318, lost incremental demand from removed item 306, horizontal transfer of demand from item 306 to items 304, 308, and 318, as well as horizontal cannibalized demand transfer away from legacy items 304, and 308 to new item 318.

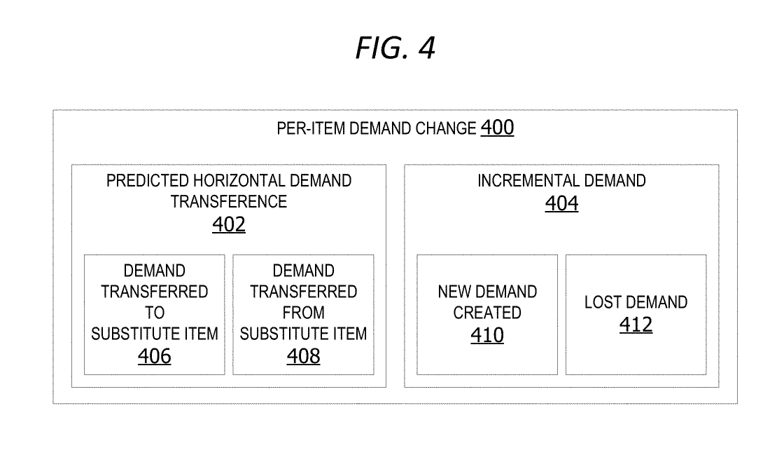

FIG. 4 is an exemplary block diagram illustrating per-item demand change 400 due to an assortment change. A per-item demand change 400 is an identification of an amount of change in demand associated with each item in an assortment due to one or more changes in the assortment. Demand change may be quantified in terms of a percentage of units of an item, a percentage of cases of an item, the number of units of an item, the number of cases of an item, a monetary value, a score, and/or a ranking.

A demand change may include a predicted horizontal demand transference 402 from one item to another item and/or an incremental demand 404 associated with a single item. The predicted horizontal demand transference 402 includes an identification of demand transferred to a substitute item 406 and/or demand transferred from a substitute item 408. Demand transferred horizontally from one item to another item is demand that is maintained or preserved by the proposed item assortment. However, when demand is transferred from one legacy item to a new item being added to the item assortment, the demand transfer is not beneficial because the new item is cannibalizing demand from a legacy item.

Incremental demand 404 includes new demand created 410 by adding a new item to an assortment and lost demand 412 due to removal of an item from a current item assortment. The new demand created 410 is incremental demand generated by the new item. The lost demand 412 is the amount of demand attributable to an item being removed from an assortment that does not transfer to another item in the assortment. This non-transferred demand is lost.

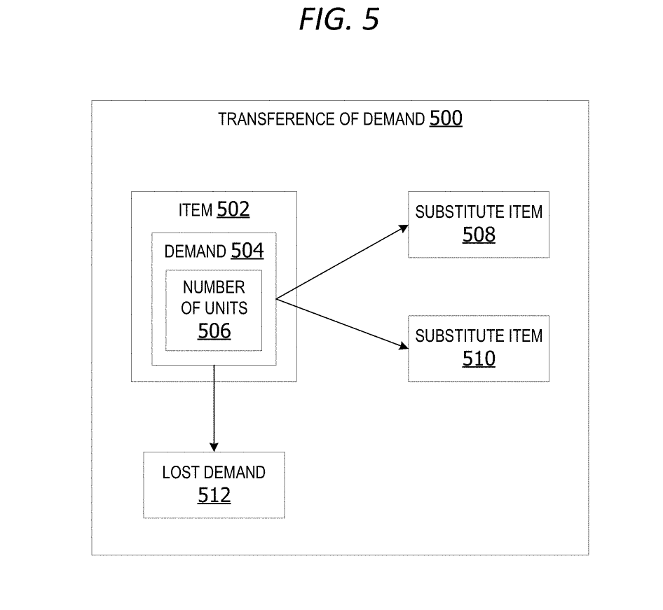

FIG. 5 is an exemplary block diagram illustrating transference of demand 500 identified by a demand prediction component for a suggested removal of an item 502 from a current item assortment, such as the current item assortment 302 in FIG. 3. The demand prediction component calculates an amount of demand 504 attributable to the item 502. This demand 504 may be quantified as the number of units 506 of the item 502 selected by users within a predetermined time-period. The demand 504 in other examples may be quantified as a percentage of units, a percentage of cases, the number of cases, and/or any other type of item quantity.

This example, a portion of the demand 504 transfers from item 502 to a substitute item 508 within the proposed item assortment. Another portion of the demand 504 of item 502 transfers to another substitute item 510. Lost demand 512 is a magnitude of un-transferred demand attributable to item 502 which is predicted to be lost if item 502 is removed from the current item assortment.

For example, if item 502 has a demand 504 of one-hundred units per week time-period, the predicted transference of demand 500 may include an estimated fifty units of the demand from item 502 transferring to substitute item 508 and only ten units of the demand 504 transferring to substitute item 510. In this example, the portion of the demand 504 that is lost demand 512 is estimated to be approximately forty units.

FIG. 6 is an exemplary block diagram illustrating a demand prediction component 600 for generating a per-assortment demand transference result 602. The demand transference result in some examples includes an identification of each item in an assortment which is predicted to experience an increase or a decrease in demand due to an assortment change. The demand transference result also includes a magnitude of the increase or decrease in demand predicted for each identified item. The magnitude of the demand change for each item may be quantified as a percentage increase or decrease, the number of units increase or decrease, the number of cases increase or decrease, or any other quantification of demand associated with each item.

The demand prediction component 600 in some examples includes an item selection component 604. The item selection component 604 analyzes item attribute data 606 describing one or more attributes of items in a plurality of items 608 included within a proposed item assortment 610 and/or a current item assortment 620 associated with current inventory 622. The item selection component identifies a set of substitute items 612 for the proposed item assortment 610 based on the results of the analysis.

The set of substitute items 612 includes two or more items having one or more attributes which are the same or similar. In some examples, items in the set of substitute items 612 are items in a same category or items of a same type. For example, items in the set of substitute items 612 may all be candy-related items in a candy category. In another non-limiting example, items in the set of substitute items 612 may include t-shirt items in a same t-shirt category.

In some examples, the item selection component analyzes item attribute data 606 for each item in the plurality of items 608 with transaction data 614 associated with the plurality of items 608 generated during a predetermined time-period 616, assortment data 615 and/or sensor data 618 generated by a plurality of sensor devices, such as the plurality of sensor devices 116 in FIG. 1. The predetermined time-period 616 may be any configurable time-period. In some examples, the predetermined time-period may be a day, a week, a month, a quarter, a year, or any other user-defined amount of time.

The item selection component identifies the set of substitute items 612 for the proposed item assortment 610 based on the analysis of the item attribute data, the transaction data, and/or the sensor data, in some examples. A demand transference modeling component 624 analyzes the item attribute data for items in the set of substitute items 612 in a demand transfer model 626 to generate a predicted transfer of demand 642 between the items in the set of substitute items 612. The transfer of demand 642 may also be referred to as the demand transference.

An item is a stronger substitute for similar items than it is for dissimilar items. In some examples, the demand transfer model 626 utilizes similarity score(s) 628 for the items in the set of substitute items 612 in calculating the predicted transfer of demand due to the assortment change(s) provided by the proposed item assortment 610. A scoring component 630 in these examples generates a similarity score for each pair of items in the set of substitute items 612. A similarity score indicates a degree of similarity between two or more items in the set of substitute items 612. In some examples, each pair of items in the set of substitute items has its own similarity score. The similarity score for a given pair of items indicates how similar one item is to another identified item.

The similarity score assigned to each pair of items is a per-assortment similarity score. In other words, if the assortment changes, the item similarity score for each item also changes. The scoring component 630 generates the similarity score(s) 628 based on an analysis of the item attribute data and/or historical assortment data 634.

In some examples, a higher similarity score indicates a greater similarity between two items. As the similarity score for two items increases, it indicates a greater degree of similarity between the two items and a greater likelihood of demand transfer from one of the items to the other item in the pair of items. A lower similarity score for a pair of items indicates a lower likelihood of transfer demand from one item in the pair to another item in the pair of items.

The demand transference modeling component 624 in still other examples utilizes historical assortment data 634, including demand patterns 636 associated with items in the proposed item assortment 610 to predict transfer of demand between items in the set of substitute items 612. The demand patterns 636 includes historical item-demand patterns associated with various item assortment combinations at the same retail environment and/or historical assortment data associated with one or more other retail environments.

In some examples, the demand transference modeling component 624 calculates a transfer of demand 642 between each item in the identified set of substitute items 612 predicted to occur in response to a proposed removal of one or more items from the current item assortment 620. The transfer of demand 642 includes a predicated transference of at least a portion of demand from the one or more removed items to one or more items in the set of substitute items 612.

A results component 638 generates a per-assortment demand transference result 602 customized for the retail environment and the proposed item assortment 610 based on the calculated transfer of demand 642. The demand transference result 602 is customized for a particular retail environment and/or a specific store because demand is driven in part by attributes such as price, local store-level promotions, and heterogeneous preference across stores. Capturing these aspects in a response model is further complicated by the fact that assortments and prices observed in empirical data are unlikely to be exogenous. Finally, retailers determine pricing to items at a store-level. Therefore, the demand transference prediction is customized at a store level.

The demand transference result 602 in some examples is a per-assortment result because demand associated with a given item is not fixed. The demand associated with one item is influenced by other similar items in the same assortment. Each item that is added or removed from an assortment potentially may alter the demand for one or more other items in the assortment. In some examples, removing an item and/or adding an item may change the demand associated with all items in the set of substitute items associated with that item. For example, if a gallon size milk item is removed it may increase sales of one or more other gallon size milk items as well half-gallon size milk items in the same assortment as a result of item substitution.

The demand transference result 602 in some examples includes a demand transference score 640 generated by the scoring component 630. In these examples, the scoring component 630 analyzes the demand transference result 602 using one or more threshold(s) 632 and/or historical demand transference data to generate the demand transference score 640. The demand transference score 640 is a value indicating a ranking of the proposed item assortment 610 relative to a scale and/or relative to one or more other assortments.

The results component 638, in some examples, outputs the demand transference result 602 via a user interface component, the per-assortment demand transference result includes an identification of each item in the set of substitute items predicted to receive at any portion of the demand transferred from the identified item and a magnitude of demand transferred to each item.

In other non-limiting examples, the item selection component 604 optionally utilizes one or more similarity score threshold values in the one or more threshold(s) 632 to identify items in the set of substitute items 612.

A database 644, in other examples, may be included to store data, such as, but not limited to, the item attribute data 606, the transaction data 614, the sensor data 618, the threshold(s) 632, assortment data, such as the current item assortment 620 and/or historical assortment data, and/or any other data utilized by the demand prediction component. The database 644 may be implemented within a data storage device, such as, but not limited to, the data storage device 125 in FIG. 1.

In some examples, the demand prediction component 600 models store level item sales based on attributes. The items may be identified using UPC data or other item identifier (ID), such as RFID tag data, matrix barcode data, etc. The item ID is used to identify trade items in stores across different regions and areas/markets. The assortment of items and attributes of items may vary across different regions.

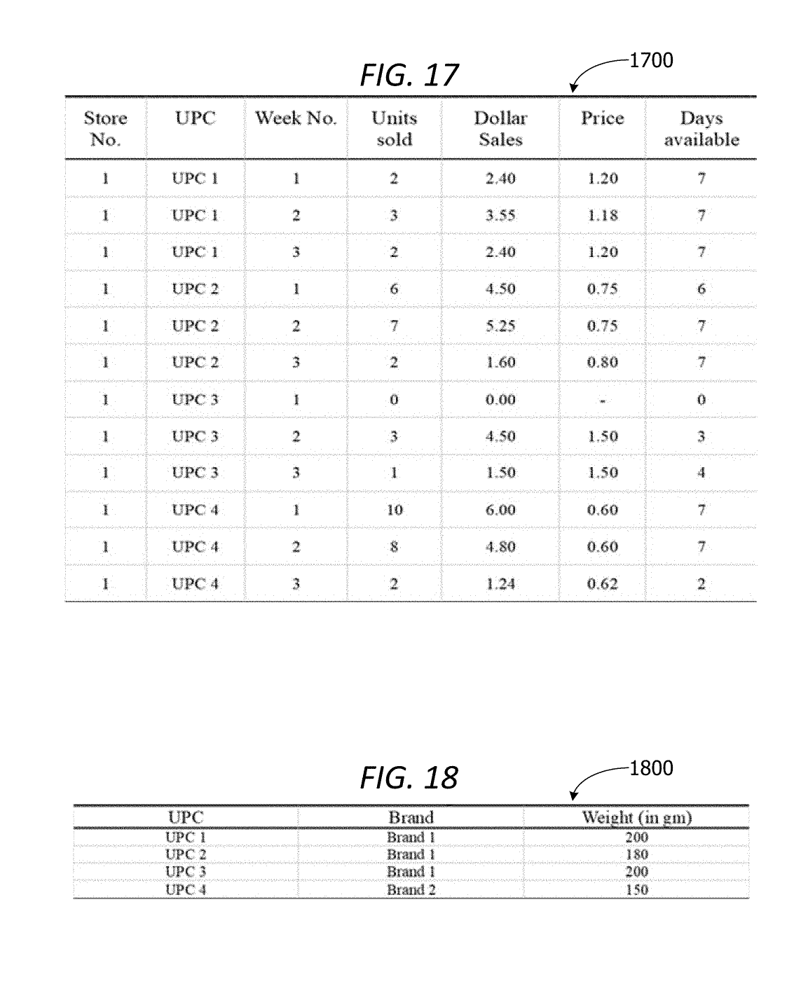

To model item demand at a store level, the demand prediction component 600 analyzes store-level item data and sensor data to obtain a holistic view of the available assortment in the given store. One example of the input data is provided in table 17 in FIG. 17 below.

The demand prediction component 600 models item demand based on item attributes in some examples because users may not form preference for each individual item in an assortment but instead they form preferences for the underlying attributes (e.g., size, brand, flavor, etc.) of the items in the assortment.

The demand prediction component 600 takes into account the attributes of all items in a set of substitute items for a given assortment to model per-item demand customized at a store-level. Apart from the attributes of an item to be deleted or added to an assortment, the attributes of other available similar items in the assortment may also influence demand. Therefore, the demand prediction component 600 incorporates variables to account for per-item attribute similarity as well as cross attribute similarity with a combination of items in each assortment. In other words, the similarity of one item with another is influenced not only by the attributes of each item but it is also altered by the combination of items in the set of substitute items.

The demand prediction component 600 in some examples is an attribute based model that highlights the role similarity variables play in demand transference. While modeling the item demand at a store level, the demand prediction component 600 allows for flexible substitution patterns, and non-linear effects by starting with a log-log model.

$$log ( {S}_{kti} ) = {\underbrace{{α}_{ki}}}_{A} + {\underbrace{β \cdot log ( {P}_{kti} )}}_{B} + {\underbrace{{\sum }_{m ∈} {γ}_{kmti}}}_{C} \qquad ( 1 )$$

where,

Sₖₜᵢ=unit sales of item k∈{1, 2, . . . , K} in week t∈{1, 2, . . . , T} in store I∈{1, 2, . . . , n};

αₖᵢ=item-store intercept for item k∈{1, 2, . . . , K} in store I∈{1, 2, . . . , n};

Pₖₜᵢ=price of item k∈{1, 2, . . . , K} in week t∈{1, 2, . . . , T} in store I∈{1, 2, . . . , n};

Yₖₘₜᵢ=similarity score of item k∈{1, 2, . . . , K}, for attribute m∈ [symbol] , in week t∈{1, 2, . . . , T} in store I∈{1, 2, . . . , n};

[symbol] =set of all attributes, evaluated for all items in a product category;

Further, αₖᵢ may be replaced by strictly store level intercepts along with attribute dummies such that:

$${α}_{ki} = {\underbrace{{α}_{i}}}_{A} + {\underbrace{{\sum }_{m ∈} {\sum }_{l = 1}^{{m}_{1}} {A}_{kml}}}_{B} \qquad ( 2 )$$

where,

Aₖₘₗ=1 if item k possesses level 1 of attribute m∈ [symbol] , and 0 otherwise, if m is nominal and where,

Aₖₘₗ=the realization of attribute m∈ [symbol] , if m is metric.

The similarity score(s) 628 of an item k, in some examples, for a nominal or metric attribute m, in week t, in store i is defined such that it varies between 0 (minimum similarity) and 1 (maximum similarity), and, also reflects the similarity of the item k relative to the distribution of attribute m in the entire available assortment.

In one example, the magnitude of similarity between two items, such as between item k and item k′, is denoted as SIM_{kk′mti} with respect to attribute m in store i in week t. If item k and item k′ share the same level of nominal attribute m, the perceived similarity between item k and item k′ is stronger when their shared attribute level occurs less frequently. We obtain all the above, by defining:

$${SIM}_{{kk}^{′} mti} = 1 - \frac{1}{{N}_{ti}} \cdot {\sum }_{{{k}^{″} = 1}_{{x}_{{k}^{″} ti} = 1}}^{K} I \{ min ( {A}_{k m} , {A}_{{k}^{′} m} ) \leq {A}_{{k}^{″} m} \leq max ( {A}_{k m} , {A}_{{k}^{′} m} ) \} \qquad ( 3 b )$$

if attribute m is metric. This definition is numerically illustrated for weight attribute in table 21 in FIG. 21 below. The demand prediction component 600 describes the measure of similarity for item k and item k′, the demand prediction component 600 formulates the similarity score of item k for attribute m in week tin store i as:

γₖₘₜᵢ=mean*_{k′≠k}(SIM_{kk′mti}) (4)

where,
mean*(.)=Arithmetic Mean of the non-zero elements of the argument, if attribute m is nominal, usual Arithmetic Mean otherwise.

The demand prediction component 600 in some examples utilizes categories of items to determine item similarity and transfer of demand. A category of items may include food items and non-food items. Categories may be more specific, such as categories of food items. For example, categories may include dairy items, bakery items, candy items, produce items, etc. A category may include sub-categories. For example, a milk group may include an almond milk sub-category, a coconut milk sub-category, a soy milk sub-category, a chocolate milk sub-category, white milk sub-category, etc.

The demand prediction component 600 may model demand transfer between items in a single category, as well as a single sub-category. Each category or sub-category has its own unique and consists of widely different varieties of items having different item IDs. Within a category, demand may transfer from one item to every other item in the category. In other examples, demand only transfers between items within a set of substitute items. In these examples, the items in the set of substitute items share a minimum degree of similarity with regard to one or more item attributes. The demand prediction component 600 performs the demand transference analysis over each substitutable group, as if assuming it to be a small sized category or sub-category.

The demand prediction component 600 performs a linear regression as mentioned in (1), all regression sanity checks are taken care of and the final model consists of the uncorrelated and significant regressors among the ones mentioned in (1).

The demand prediction component 600 calculates a magnitude of demand transference and the walk-off rate for items in the set of substitute items. The demand prediction component 600 defines:

[symbol] ᵢ: the training assortment of store i;

[symbol] ′ᵢ: the assortment of store i after the assortment change.

For every item in [symbol] ᵢ, the demand prediction component 600 obtains the predicted weekly unit sales from the model as explained in (1). The values of parts A and B in (1) are independent of the store assortment (assuming there is no change in price in any of the items in [symbol] ᵢ) and thus doesn't change. In these examples, the demand prediction component 600 computes these values only for those items that have been introduced in [symbol] ′ᵢ but were not a part of [symbol] ᵢ. Part C in (1) directly depends upon the current assortment in store and hence the demand prediction component 600 recalculates the similarity score for each item in the new assortment.

Once the demand prediction component 600 has all the required information, the demand prediction component 600 obtains the predicted weekly unit sales of every item in [symbol] ᵢ. Define,

Ŝₖᵢ=predicted weekly unit sales of item k∈ [symbol] ᵢ;

Ŝₖᵢ′=predicted weekly unit sales of item k∈ [symbol] ′ᵢ.

Therefore, ΔSₖᵢ=Ŝₖᵢ′−Ŝₖᵢ, is the change in the weekly unit sales of item k∈ [symbol] ᵢ∩ [symbol] ′ᵢ. But, ΔSₖᵢ=Ŝₖᵢ′, if item k∈ [symbol] ′ᵢ/ [symbol] ᵢ.

In the case of a proposed deletion or removal of a set of one or more items from a current item assortment, the demand prediction component 600 defines,

[symbol] _{del}=set of items deleted from [symbol] ᵢ, and are not present in [symbol] ′ᵢ.

### Then:

$${Δ}_{k {𝔸}_{i}^{′}}^{del} = \frac{{ΔS}_{ki}}{{\sum }_{t ∈ {𝒰}_{del}} {\hat{S}}_{ti}} \cdot 100 \% \qquad ( 5 a )$$

where, [symbol] =demand of items in [symbol] _{dei} transferred to item k, ∇k∈ [symbol] ′ᵢ. The demand prediction component calculates the walk-off rate as:

$${ω}_{{𝔸}_{i}^{′}}^{del} = 100 - {\sum }_{k ∈ {𝔸}_{i}^{′}} {Δ}_{k {𝔸}_{i}^{′}}^{del} \qquad ( 5 b )$$

For the case of a proposed addition of a set of one or more new item to a current item assortment, the demand prediction component 600 defines,

[symbol] _{add}=set of items added to [symbol] ′ᵢ, but were not a part of [symbol] ᵢ.

### Then,

$${Δ}_{k {𝔸}_{i}^{′}}^{add} = \frac{\vert {ΔS}_{ki} \vert}{{\sum }_{t ∈ {𝒰}_{add}} {\hat{S}}_{ti}^{′}} \cdot 100 \% \qquad ( 6 a )$$

where,

[symbol] =demand of items in [symbol] _{add} cannibalized from item k, ∇k∈ [symbol] ′ᵢ.

Herein, the incrementality in some examples is calculated by the demand prediction component 600 as:

$${ω}_{{𝔸}_{i}^{′}}^{add} = 100 - {\sum }_{k ∈ {𝔸}_{i}^{′}} {Δ}_{k {𝔸}_{i}^{′}}^{add} \qquad ( 6 b )$$

If a proposed item assortment includes both addition of a set of one or more items and deletion of a set of one or more items, the demand prediction component 600 calculates the magnitude or amount of change in the demand for item k due to the transfer of demand from the deleted items and the magnitude or amount of demand change for each item due to cannibalization of demand away from the added items and the amount of demand transference towards the newly added items, as well

Hence, one may separately consider the deletions and additions to obtain the demand transference measures. Therefore, the demand prediction component 600 in some examples calculates the demand transference at least in part as:

$$\begin{matrix}{Δ}_{k {𝔸}_{i}^{′}}^{add} = \frac{\vert {ΔS}_{ki} \vert \cdot \frac{\vert {𝒰}_{add} \vert}{\vert {𝒰}_{del} \vert}}{{\sum }_{t ∈ {𝒰}_{add}} {\hat{S}}_{ti}^{′}} \cdot 100 \% , ∀ k ∈ {𝔸}_{i}^{′} & ( 7 a ) \\ {Δ}_{k {𝔸}_{i}^{′}}^{del} = \frac{{ΔS}_{ki} \cdot \frac{\vert {𝒰}_{del} \vert}{\vert {𝒰}_{add} \vert}}{{\sum }_{t ∈ {𝒰}_{del}} {\hat{S}}_{ti}} \cdot 100 \% , ∀ k ∈ {𝔸}_{i}^{′} & ( 7 b )\end{matrix}$$

where,

[symbol] =demand of items in [symbol] _{add} cannibalized from item k, ∇k∈ [symbol] ′ᵢ.

[symbol] =demand of items in [symbol] _{del} transferred to item k, ∇k∈ [symbol] ′ᵢ.

### In (7b),

$$Δ {S}_{ki} = Δ {S}_{ki} \cdot ( 1 - {\sum }_{t ∈ {𝒰}_{add}} \frac{{Δ}_{k {𝔸}_{i}^{′}}^{add}}{100} \cdot I \{ k ∈ {𝒰}_{add} \} ) \qquad ( 7 c )$$

Therefore, in some examples the demand prediction component calculates the walk-off rate as:

$${ω}_{{𝔸}_{i}^{′}}^{add} = 100 - {\sum }_{k ∈ {𝔸}_{i}^{′}} {Δ}_{k {𝔸}_{i}^{′}}^{del} \qquad ( 7 d )$$

and incrementality is defined in as:

$${ω}_{{𝔸}_{i}^{′}}^{add} = 100 - {\sum }_{k ∈ {𝔸}_{i}^{′}} {Δ}_{k {𝔸}_{i}^{′}}^{add} - {\sum }_{k ∈ {𝒰}_{add}} {Δ}_{k {𝔸}_{i}^{′}}^{del} \qquad ( 7 e )$$

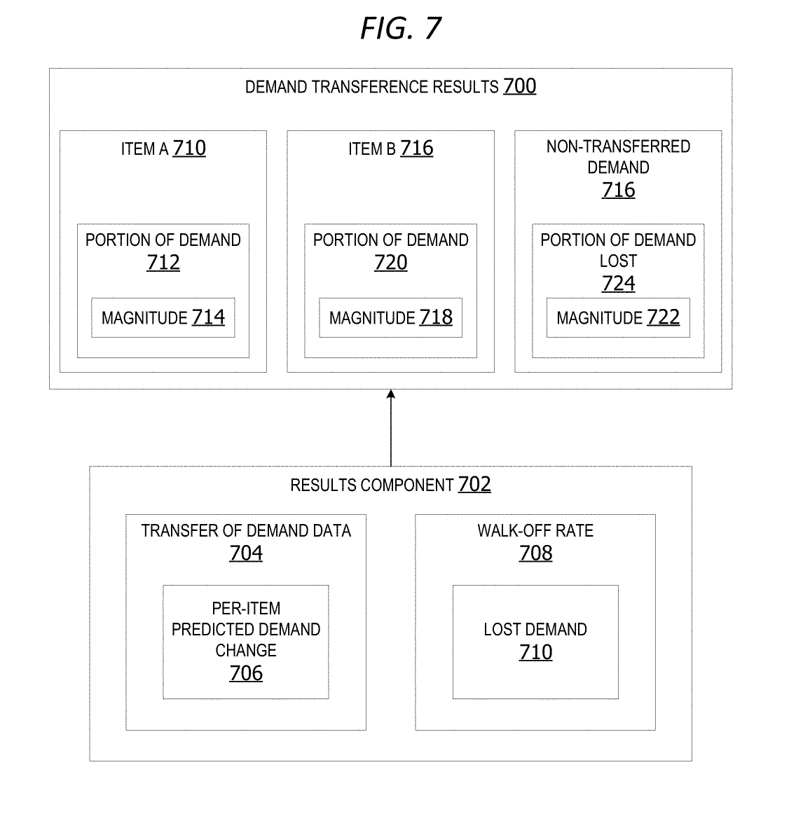

FIG. 7 is an exemplary block diagram illustrating a demand transference result 700 generated by a results component 702. The results component 702 receives transfer of demand data 704 from the demand transference modeling component. The transfer of demand data 704 includes data describing the transfer of demand between items in a set of substitute items, such as the transfer of demand 642 in FIG. 6.

The transfer of demand data 704 includes a per-item predicted demand change 706. The demand change 706 may include an increase in demand due to demand creation or demand transfer to an item away from another item in the assortment. The demand change 706 also includes a decrease in demand due to lost demand or demand transferred away from an item to another item.

The per-item predicted demand change identifies each item in the set of substitute items for a given proposed item assortment and provides a magnitude of demand transfer to or from each item due to one or more proposed changes in assortment, such as the set of assortment changes 204 in FIG. 2.

The results component 702 may optionally also receive a walk-off rate 708 identifying an amount or quantity of lost demand associated with one or more items in a proposed assortment due to proposed assortment changes. The lost demand 710 may quantify demand lost as the number of units of an item remaining on a shelf (lost sales), percentage of sales lost for an item, or any other quantity associated with an item to be removed from the current item assortment.

The results component 702 analyzes the transfer of demand data 704 and/or the walk-off rate to generate the demand transference result 700. The demand transference result 700 includes an identification of each item in the set of substitute items and a magnitude of demand transferred to the item, a magnitude of demand transferred away from the item, a magnitude of demand created by addition of a new item and/or a magnitude of demand lost by removal of a legacy item.

In this non-limiting example, the demand transference result 700 includes an identification of a substitute item A along with an identification of a magnitude 714 of a portion of demand 712 transferred from item C (not shown) to item “A” as a result of removal of item C from the current item assortment. The demand transference result 700 in this example also includes an identification of a substitute item “B” 716 with a magnitude 718 of a portion of demand 720 transferred from item C to item 716 due to the proposed removal of item C. The demand transference result 700 also includes an identification of a magnitude 722 of a portion of demand associated with item C that is predicted to be lost 724 due to non-transferred demand 726 from item C.

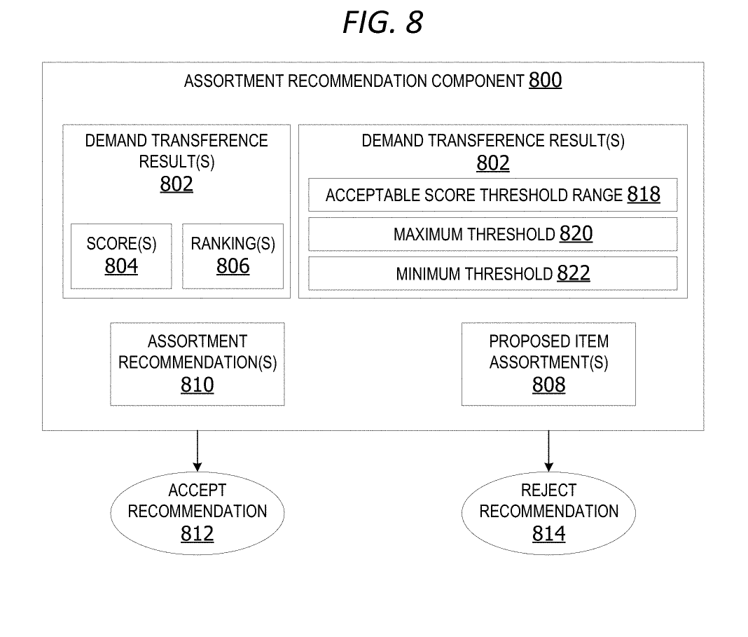

FIG. 8 is an exemplary block diagram illustrating an assortment recommendation generated by an assortment recommendation component 800. The assortment recommendation component 800 analyzes one or more demand transference result(s) 802 associated with one or more proposed item assortment(s) 808 to determine whether to recommend a given proposed item assortment should be accepted or rejected. The demand transference result(s) 802 may include one or more score(s) 804 and/or one or more ranking(s) 806 for comparing the proposed item assortment to one or more other possible item assortments, an assortment/demand transference quality scale, or other criteria.

The assortment recommendation component 800 outputs assortment recommendation(s) 810 based on the demand transference result(s) 802, the score(s) 804, and/or the ranking(s) 806. The assortment recommendation(s) 810 may include an accept recommendation 812 or a reject recommendation 814.

The assortment recommendation component 800 generates the accept recommendation 812 if the predicted demand transference for a given item assortment indicates overall positive demand transference for the assortment. Positive demand transference refers to an assortment in which an amount of new demand created by addition of a new item and/or horizontal transference from legacy items to the new item is minimal.

The assortment recommendation component 800 in some examples compares the predicted demand transference score for a given proposed item assortment with one or more threshold scores. The assortment recommendation component 800 outputs an accept recommendation 812 if the demand transference result score is within an acceptable score threshold range 818 and/or the new demand created by assortment changes are greater than one or more minimum threshold(s) 822. The assortment recommendation component 800 may output the recommendation with the predicted demand transference result and/or the predicted demand transference score for the proposed item assortment.

In still other examples, the assortment recommendation component 800 outputs the reject recommendation 814 if the predicted demand transference for a given item assortment indicates a negative demand transference for the assortment. A negative demand transference refers to an assortment in which significant demand is lost due to assortment changes, such as removal of a legacy item and/or significant cannibalization of demand from legacy items to one or more new items.

In other examples, the assortment recommendation component compares the predicted demand transference score with one or more threshold scores. The assortment recommendation component 800 generates the reject recommendation 814 if the demand transference result score is falls outside the acceptable score threshold range 818 and/or the lost demand created by assortment changes is greater than one or more maximum threshold(s) 820. The assortment recommendation component 800 may output the recommendation alone or the assortment recommendation component 800 may output the reject recommendation with the predicted demand transference result and/or the predicted demand transference score for the proposed item assortment.

Assortment is frequently an important element in differentiating one store from another regarding competition and actual sales. The assortment recommendation, along with the demand transference result, and/or score output by the demand prediction component and assortment recommendation component assist a user in selecting an optimal assortment that maximizes category profitability, without sacrificing customer satisfaction.

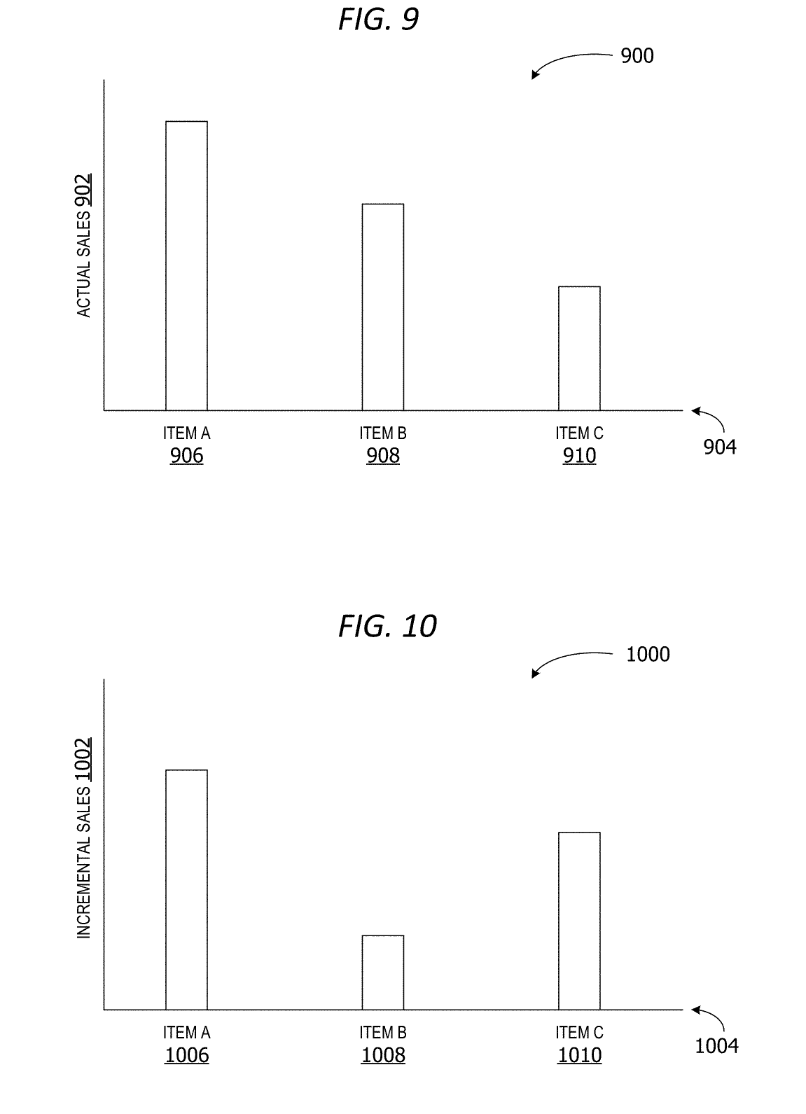

FIG. 9 is an exemplary graph 900 illustrating demand for a set of substitute items. The graph 900 demonstrates the number of actual sales 902 along a y-axis for each item 904 along the x-axis. In this example, the items include item “A” 906, item “B” 908, and item “C” 910. Item 906 shows the strongest demand in terms of actual sales and item 910 shows the weakest demand.

Typically, an item is selected for deletion from a current item assortment based on ranking of the items in the assortment in accordance with number of sales. In this example, the item 910 having the lowest actual sales would be selected for removal from the assortment as the lowest selling item. However, the item 910 may have a high incremental demand and therefore low demand transference. Therefore, removal of item 910 is likely to be unbeneficial.

The demand transference model analyzes the item attribute data for items 906, 908, and 910 along with transaction data, store-level assortment data, context data, and other demand-related data to generate a more accurate demand transference prediction which accounts for incremental demand. This predication indicates how demand from item 910 would be transferred to other ‘substitutable’ items in the same assortment. This assists user in identifying items having low incremental demand as well as low actual sales to minimize lost incremental demand.

FIG. 10 is an exemplary graph illustrating incremental demand for the set of substitute items. The graph 1000 demonstrates incremental sales 1002 along a y-axis for each item 1004 along the x-axis. The graph 1000 illustrates item “B” 908 shows the weakest predicted incremental demand. Item 910 shows significant predicted incremental demand which would be lost if item 910 were removed from the current item assortment. Thus, although the graph 900 in FIG. 9 shows relatively weak sales for item 906, most of the demand for item “C” would not transfer to another item. In this example, the assortment recommendation component would recommend a proposed assortment removing item 906 from the current item inventory should be rejected due to the significant lost incremental demand associated with item 906.

FIG. 11 is an exemplary graph 1100 illustrating demand transference between substitute items. The graph 1100 shows a percentage 1102 of demand transferred from an item A to be removed from a current item assortment to a set of substitute items. In this non-limiting example, the total transferred units of item A 1104 transferred to the set of substitute items is approximately 25% of total demand. The amount of lost demand 1106 predicted to occur due to incremental demand of item A is approximately 75% in this example. The graph illustrates the magnitude of demand transferred to each item in the set of substitute items. For example, item B receives a portion of demand 1108, item C receives a portion of demand 1110, item D receives a portion of demand 1112, item E receives a portion of demand 1114, and item F receives a portion of demand 1116 transferred from item A.

In this example, the assortment recommendation component 800 in FIG. 8 generates a reject recommendation to reject the proposed item assortment due to the predicted 75% lost demand associated with the proposed item assortment.

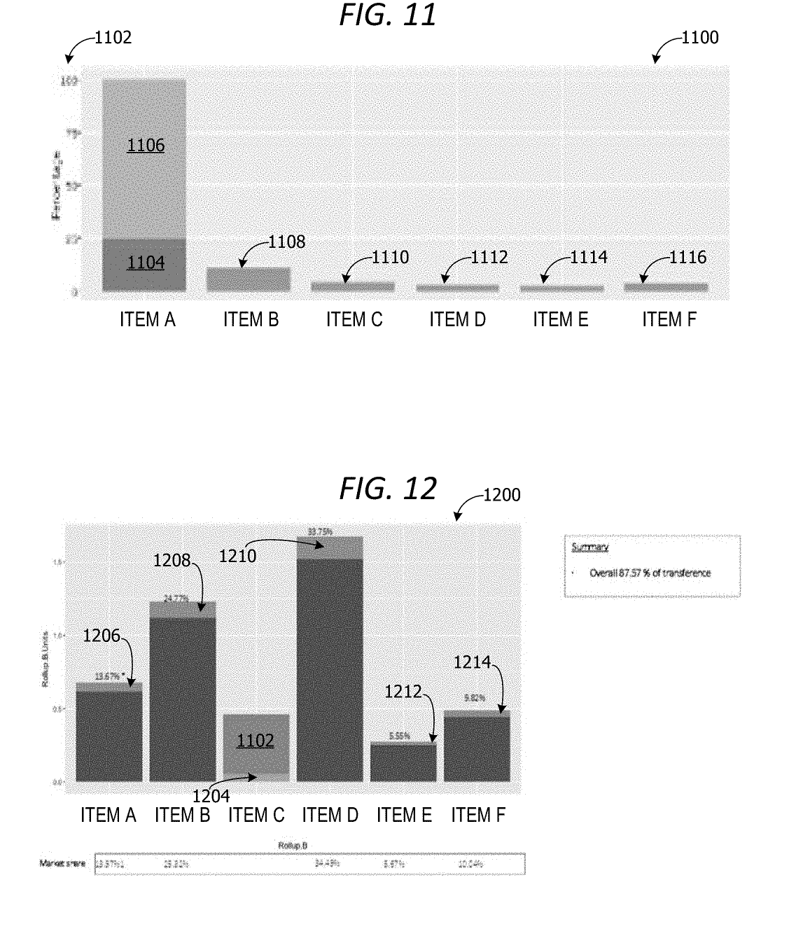

FIG. 12 is another exemplary graph 1200 illustrating demand transference between substitute items. In this example, if an item C is removed from a current item assortment, the predicted demand transference results indicate a total transference of demand 1202 of approximately 87.57% with a loss of demand 1204 of 14.43%. In this example, item A receives 13.67% of the transferred demand at 1206, item B receives 24.77% of the transferred demand at 1208, item D receives 33.75% of the demand at 1210, item E receives 5.55% of the transferred demand at 1212, and item F receives 9.82% of the demand transference at 1214.

In this example, the assortment recommendation component 800 in FIG. 8 generates a reject recommendation to accept the proposed item assortment due to the predicted 87.75% demand transference associated with the proposed removal of item C from the item assortment.

FIG. 13 is an exemplary flow chart illustrating operation of the computing device to generate a demand transference result. The process shown in FIG. 13 may be performed by a demand prediction component, executing on a computing device, such as the computing device 102 in FIG. 1.

The process begins by receiving a proposed item assortment at 1302. The proposed item assortment is a proposed assortment including at least one assortment change to a current item assortment, such as, the proposed item assortment 310 in FIG. 3. A horizontal transference of demand between items is calculated at 1304. The transfer of demand is calculated by a demand prediction component, such as the demand prediction component 124 in FIG. 1 and/or the demand prediction component 600 in FIG. 6.

A determination is made as to whether one or more item(s) are removed from the assortment at 1306. The one or more item(s) include at least one item associated with a retail environment, such as, but not limited to, the plurality of items 608 in FIG. 6. The one or more item(s) are associated with an environment, such as the retail environment 118 in FIG. 1.

If one or more item(s) are removed from the assortment in accordance with the proposed item assortment at 1306, a lost incremental demand is calculated at 1308. The lost incremental demand quantifies a predicted magnitude of demand associated with an item removed from a current assortment that is not transferred to another item in the assortment, such as the lost demand 412 in FIG. 4 and/or the lost demand 512 in FIG. 5.

A determination is made as to whether one or more item(s) are added to the assortment by the proposed item assortment at 1310. If yes, a new incremental demand is calculated at 1312. The new incremental demand is new demand generated by addition of the one or more item(s), such as the new demand created 410 in FIG. 4.

A demand transference result is generated at 1314. The demand transference result includes an identification of each item experiencing a change in demand and a magnitude of the demand change associated with each item, such as, but not limited to, the demand transference result 130 in FIG. 1, the demand transference result 602 in FIG. 6, and the demand transference result(s) 802 in FIG. 8. The demand transference result is output at 1412. The result may be output via a user interface, such as the user interface device 110 in FIG. 1. The demand transference result may also be output via a communications interface for sending data to a remote user device via a network, such as the communications interface component 134 in FIG. 1. The process terminates thereafter.

While the operations illustrated in FIG. 13 are performed by a computing device, aspects of the disclosure contemplate performance of the operations by other entities. For example, a cloud service may perform one or more of the operations.

FIG. 14 is an exemplary flow chart illustrating operation of the computing device to generate a demand transference score. The process shown in FIG. 14 may be performed by a demand prediction component, executing on a computing device, such as the computing device 102 in FIG. 1.

The process begins by receiving a proposed item assortment at 1402. A determination is made as to whether the proposed item assortment includes an assortment change at 1404. The assortment change is a change that adds at least one item to an assortment and/or removes at least one item from the assortment, such as, but not limited to, the set of assortment changes 202 in FIG. 2. If no, the process terminates thereafter.

If there is an assortment change at 1404, the proposed item assortment is analyzed using item attribute data to identify a set of substitute items at 1408. The item attribute data is data describing one or more attributes of an item, such as, but not limited to, the item data 120 in FIG. 1 and/or the item attribute data 606 in FIG. 6. A demand transference score for the proposed item assortment is calculated at 1410. The demand transference score is a score ranking the demand transference for the proposed item assortment, such as, but not limited to the demand transference score 640 in FIG. 6, the score(s) 804 in FIG. 8, and/or the ranking(s) 806. The demand transference score and demand transference result is output at 1412. The score and the result may be output via a user interface, such as the user interface device 110 in FIG. 1. The score and the result may also be output via a communications interface for sending data to a remote user device via a network, such as the communications interface component 134 in FIG. 1. The process terminates thereafter.

While the operations illustrated in FIG. 14 are performed by a computing device, aspects of the disclosure contemplate performance of the operations by other entities. For example, a cloud service may perform one or more of the operations.

FIG. 15 is an exemplary flow chart illustrating operation of the computing device to generate an item similarity score. The process shown in FIG. 15 may be performed by a demand prediction component, executing on a computing device, such as the computing device 102 in FIG. 1.

The process begins by analyzing item attribute data for each item in a set of substitute items associated with a proposed assortment at 1502. The set of substitute items is a set of two or more items sharing at least one attribute, such as, but not limited to, the set of substitute items 612 in FIG. 6. An item similarity score is generated for each item-pair in a set of substitute items in the assortment at 1504. A determination is made as to whether a new item assortment is received at 1506. If no, the process terminates thereafter.

If a new item assortment is received at 1506, an updated item similarity score for each item in the set of substitute items associated with the new item assortment is calculated at 1508. The process terminates thereafter.

While the operations illustrated in FIG. 15 are performed by a computing device, aspects of the disclosure contemplate performance of the operations by other entities. For example, a cloud service may perform one or more of the operations.

FIG. 16 is an exemplary flow chart illustrating operation of the computing device to generate a new per-assortment demand transference score. The process shown in FIG. 16 may be performed by a demand prediction component, executing on a computing device, such as the computing device 102 in FIG. 1.

The process begins by generating a per-assortment demand transference score at 1602. A determination is made as to whether a change of store for the item assortment is made at 1604. If yes, a new per-assortment demand transference score is generated at 1610. The process terminates thereafter.

If a change in store is not entered at 1604, a determination is made as to whether a change in assortment is made at 1606. If yes, a new per-assortment demand transference score is generated at 1610. The process terminates thereafter.

Returning to 1606, if a change in assortment does not occur, a determination is made as to whether a change in time-period is entered at 1608. The time-period is a configurable amount of time, such as, but not limited to the predetermined time-period 616 in FIG. 6. The change in time-period is a change in the predetermined time-period, such as the predetermined time-period 616 in FIG. 6. If yes, a new per-assortment demand transference score is generated at 1610. The process terminates thereafter.

While the operations illustrated in FIG. 16 are performed by a computing device, aspects of the disclosure contemplate performance of the operations by other entities. For example, a cloud service may perform one or more of the operations.

FIG. 17 is an exemplary table 1700 including scanner data generated by a plurality of sensors associated with a plurality of items within a retail environment. The table 1700 refers to a snapshot of scanner data used by the demand transference modeling component for generating a demand transference result for each new proposed item assortment. The scanner data is generated by sensor devices, such as, but not limited to, the plurality of sensor devices 116 in FIG. 1. In the table 1700, the scanner data includes UPC code data. In other examples, the scanner data may include RFID tag data, matrix barcode data, OCR data, beacon data, or any other type of data which may be generated by a scanner device.

The snapshot shown in table 1700 is restricted to four UPCs generated over three weeks within a single store. Each UPC represents a unique item. However, in other examples, the scanner data may be associated with any number of unique items generated by scanner devices over a greater time-period than three weeks or during a shorter time-period. Likewise, the scanner data may be generated at two or more stores rather than limiting the scanner data to a single store.

FIG. 18 is an exemplary table 1800 including attribute data for a set of substitute items. The attribute data shown in table 1800 is data associated with the four unique items represented by the snapshot shown in FIG. 17. In this non-limiting example, the attribute data includes brand identification data for each item and weight data for each item. The brand is a nominal attribute. The weight is a metric attribute.

In other examples, the attribute data for a given item may include price-per-unit, price-per-size, item size data, item ingredients, or any other type of attribute data associated with an item.

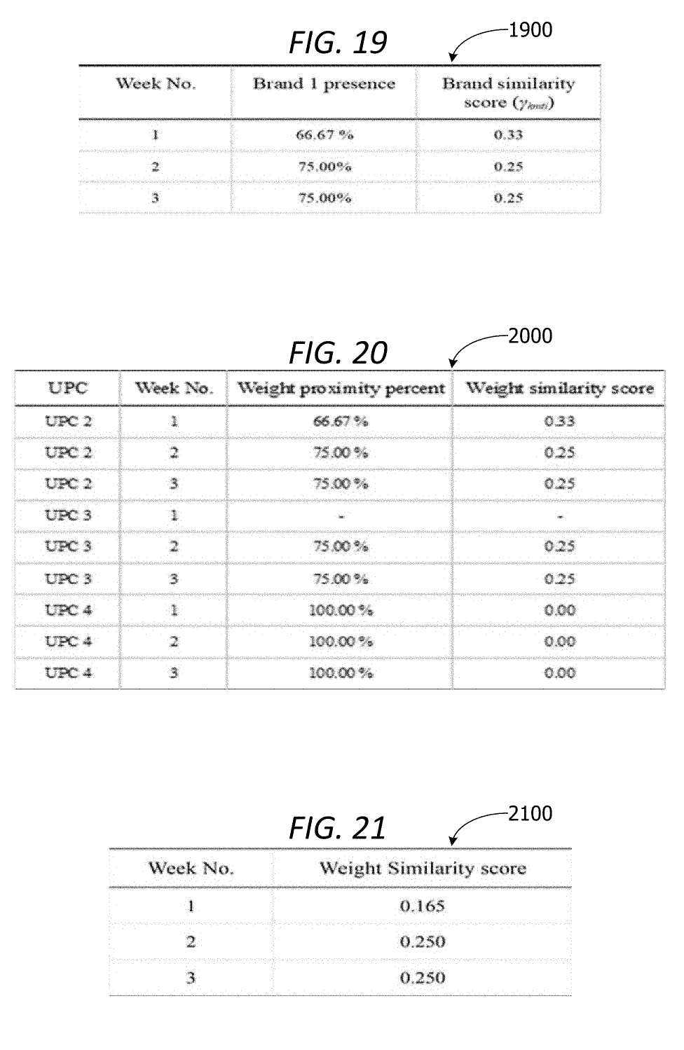

In this example, the attribute brand, brand 1 is present in 75% of the overall assortment. Brand 2 in this example is present in 25% of the overall assortment. The similarity scores for the item associated with the UPC 1 with respect to the nominal attribute brand is demonstrated in table 1900 shown in FIG. 19 below.

FIG. 19 is an exemplary table 1900 including a set of similarity scores for a first substitute item with respect to a second substitute item generated on a weekly basis. The table 1900 provides a week-wise brand similarity score for the identified item associated with UPC 1.

FIG. 20 is an exemplary table 2000 including a weekly weight proximity data for each item in a set of substitute items. Table 2000 demonstrates values for weekly weight proximity percent for each of the three items associated with UPC 2, UPC 3, and UPC 4.

FIG. 21 is an exemplary table including a weekly weight similarity score for an identified item. For the metric attribute weight, the similarity score of the identified item associated with UPC 1 is shown in table 2100.

Additional Examples

In some examples, a per-item and per-assortment quantified demand transfer value customized for a specified retail store during a specified time-period is provided as input into assortment optimization. If an item is predicted to exhibit a good extent of transference between items in the same assortment, removal of the item from the assortment results is less lost demand. Therefore, the item may be removed from inventory if it is a poor performer or less than an average performer in terms of actual sales. Conversely, the assortment optimization avoids or discourages deletion of items having less desirable actual sales but significant incremental demand with low demand transference if the item is removed from the assortment. In such cases, the assortment optimization component identifies the item as a poor candidate for removal from the assortment due to the potential loss of the bulk of that item's demand.

Other examples recognize that a per-item demand transfer customized for a specified item assortment at a given store and/or region within a specified time-period is not explicitly observed, it is latent. Therefore, the demand transference model is provided to capture it

The demand transference model in other examples utilizes data associated with item-demand trends for a given store or similar stores to more accurately predict this customized demand transference. The input data in these examples may include POS data, promotions data, item attribute data, transaction data, sensor data, context data, historical weather data, weather trends, seasonal item demand trends, local events, as well as any other data impacting item-demand at a store-level. This data is harnessed from a plurality of sensor devices, data feeds, data storage, and context data sources for this process. This enables a user to obtain demand transference results, demand transference scores, and/or assortment recommendations based on different possible combination of items in multiple different proposed assortments. A user managing an item assortment may quickly and efficiently obtain demand transference results for multiple different assortment change combinations and select the item combination with the minimized lost demand and maximized created new demand and retained horizontal demand between items.

In one example, when a proposed assortment change includes removal of a legacy item from an assortment, the item similarity based cannibalization term is impacted within the demand transference model. The demand prediction component adjusts sales/demand estimate for each of the existing items based on transference in demand due to the item removal.

In one example, the demand prediction component performs item identification to identify sets of substitute items from a plurality of items for a category with 7 substitutable groups, available in 4,500 stores. Hadoop streaming is used to execute the calculation over stores; for a single store, a mclapply function (which uses forking technique) from parallel package is used to parallelize over substitutable groups. For a fixed store, the runtime in R (using forking via mclapply) is comparable to the runtime when executed in Python without any scaling up technique. This algorithm may be run for a variety of categories, both General Merchandise and Fast-Moving Consumer Goods (like Yogurt, Light Bulbs, Dish Soap, Utility Pants, Food Storage, etc.). In some examples, the mean absolute percentage error for the demand transfer model, when validated against observed assortment changes for these categories, may be within the range of 4% to 13%.

Alternatively, or in addition to the other examples described herein, examples include any combination of the following:
the lost demand score quantifying lost sales associated with removal of the identified item from inventory;
the walk-off rate associated with the identified item further comprises a lost demand score;
an assortment recommendation component, implemented on the at least one processor, that outputs an accept recommendation associated with the proposed item assortment recommending removal of the identified item from current item assortment for the retail environment on condition the lost demand score is within an acceptable threshold range;
wherein the assortment recommendation component outputs a reject recommendation recommending retaining the identified item within the current item assortment on condition the lost demand score falls outside the threshold range;
wherein the calculated transference of demand comprises a transferred demand score;
the transferred demand score quantifying a magnitude of transference of demand from the identified item to at least one substitute item in the proposed item assortment;
an assortment recommendation component, implemented on the at least one processor, that outputs an accept recommendation associated with the proposed item assortment recommending removal of the identified item from a current item assortment on condition the transferred demand score is within a threshold range;
wherein the assortment recommendation component outputs a reject recommendation comprising a recommendation to retain the identified item within the current item assortment on condition the transferred demand score falls outside the threshold range;
wherein the proposed item assortment comprises a proposed new item to be added to a current item assortment for the retail environment;
the demand transference modeling component, implemented on the at least one processor, that calculates a demand transference away from at least one item in the plurality of items within the current item assortment to the proposed new item;
wherein the per-assortment demand transference result further comprises an identification of the at least one item predicted to lose demand to the proposed new item and a magnitude of demand transference away from the at least one item to the proposed new item;
the demand transference modeling component, implemented on the at least one processor, that calculates a per-item incremental demand associated with the selected item on addition of the selected item to the proposed item assortment;
wherein the per-assortment demand transference result further comprises an identification of the number of instances of the selected item predicted to be sold during a predetermined time-period on condition the selected item is added to inventory of a given retail store;
wherein the proposed item assortment is a first proposed item assortment, and the demand transference is a first demand transference;
the demand transference modeling component, implemented on the at least one processor, that calculates a second demand transference for a second proposed item assortment comprising a set of assortment changes;
the set of assortment changes including at least one item to be added to the plurality of items and at least one item to be removed from the plurality of items;
wherein the second demand transference is calculated based on an analysis of transaction data and attribute data associated with the plurality of items;
the results component, implemented on the at least one processor, that generates a demand transference result customized for the proposed item assortment based on the calculated second demand transference;
the demand transference result comprising an identification of each item in the plurality of items associated with a predicted change in demand due to the set of assortment changes;
a scoring component, implemented on the at least one processor, that calculates an item similarity score for each item in a set of substitute items in a first proposed item assortment, the item similarity score indicating a degree of similarity associated with at least one attribute of each item, wherein the scoring component calculates an updated item similarity score for each item in the plurality of items in a second proposed item assortment;
wherein the item similarity score for a given item changes for each proposed item assortment, and wherein the demand transference modeling component utilizes the similarity score for substitute items in an assortment using per-store item demand pattern data to generate the transference of demand between items in the set of substitute items in the given assortment;
calculating a demand transference from a first item to a second item in the plurality of items due to a proposed removal of the first item from inventory and a predicted magnitude of lost demand associated with the removal of the first item from inventory;
calculating a demand transference from a first item to a second item in the plurality of items due to a proposed addition of the second item to inventory and a predicted magnitude of new demand created by addition of the second item to the inventory;
calculating, by a scoring component, an item similarity score for each item in the plurality of items in a first proposed item assortment, the item similarity score indicating a degree of similarity associated with at least one attribute of each item;
wherein the scoring component calculates an updated item similarity score for each item in the plurality of items in a second proposed item assortment, wherein the item similarity score for a given item changes for each proposed item assortment;
calculating a second demand transference for a second proposed item assortment, the second proposed item assortment comprising a second set of items to be added to the plurality of items and a second set of items to be removed from the plurality of items;
outputting an updated demand transference result customized for the second proposed item assortment generated based on the calculated second demand transference, the updated demand transference result including an identification of each item in the set of items associated with a predicted change in demand due to an assortment change associated with the second proposed item assortment;
wherein the demand transference result comprises a predicted transfer of demand between substitute items due to a change in item assortment for a given retail store, and wherein the demand transference result varies based on each different combination of items in each different proposed item assortment;
the assortment recommendation component, implemented on the at least one processor, that outputs a recommendation to reject the proposed item assortment on condition the demand transference result indicates a lack of new demand created by addition of the selected new item or predicted horizontal demand transference away from the one or more legacy items to the selected new item is outside the acceptable threshold range to prevent cannibalization of sales associated with the legacy items;
the demand transference modeling component, implemented on the at least one processor, that calculates a second demand transference for a second proposed item assortment, the second proposed item assortment comprising a proposed set of assortment changes, the proposed set of assortment changes comprising a set of items to be added to the plurality of items and a proposed set of items to be removed from the plurality of items based on an analysis of transaction data and attribute data associated with the plurality of items;
the results component, implemented on the at least one processor, that generates a demand transference result customized for the proposed item assortment generated based on the calculated second demand transference, the transference result comprising an identification of each item in the set of items associated with a predicted change in demand due to the proposed set of assortment changes;
wherein the proposed item assortment further comprises a proposed removal of an item from the plurality of items available within the retail environment;
wherein the transference result comprises an identification of each item in the set of items predicted to experience a change in demand due to the removal of the item and a magnitude of the predicted demand transference between each item in the set of items due to the proposed removal of the item;
wherein the predicted demand transference result comprises a lost demand score indicating a magnitude of lost sales associated with the proposed item assortment;
the assortment recommendation component, implemented on the at least one processor, that generates an accept recommendation associated with the proposed item assortment on condition the lost demand score is within an acceptable threshold range;
wherein the assortment recommendation component outputs a reject recommendation recommending retaining the identified item within the current item assortment on condition the lost demand score falls outside the acceptable threshold range;
an item selection component, implemented on the at least one processor, that analyzes item attribute data for each item in the plurality of items, transaction data associated with the plurality of items during a predetermined time-period, and sensor data generated by a plurality of sensor devices within the retail environment to identify a set of substitute items for a given proposed item assortment;
a scoring component, implemented on the at least one processor, that calculates an item similarity score for each item in the plurality of items in a first proposed item assortment, the item similarity score indicating a degree of similarity associated with at least one attribute of each item;
wherein the scoring component calculates an updated item similarity score for each item in the plurality of items in a second proposed item assortment; and
wherein the item similarity score for a given item changes for each different proposed item assortment.

At least a portion of the functionality of the various elements in FIG. 1, FIG. 2, FIG. 3, FIG. 4, FIG. 5, FIG. 6, FIG. 7, and FIG. 8 may be performed by other elements in FIG. 1, FIG. 2, FIG. 3, FIG. 4, FIG. 5, FIG. 6, FIG. 7, and FIG. 8, or an entity (e.g., processor, web service, server, application program, computing device, etc.) not shown in FIG. 1, FIG. 2, FIG. 3, FIG. 4, FIG. 5, FIG. 6, FIG. 7, and FIG. 8.

In some examples, the operations illustrated in FIG. 13, FIG. 14, FIG. 15, and FIG. 16 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for per-assortment prediction of demand transfer between substitute items customized for a specific store and/or location. For example, the elements illustrated in FIG. 1, FIG. 2, FIG. 3, FIG. 4, FIG. 5, FIG. 6, FIG. 7, and FIG. 8, such as when encoded to perform the operations illustrated in FIG. 13, FIG. 14, FIG. 15, and FIG. 16, constitute exemplary means for analyzing item attribute data for each item in the plurality of items, transaction data associated with the plurality of items during a predetermined time-period, and sensor data generated by the plurality of sensor devices to identify a set of substitute items for a proposed item assortment, the proposed item assortment including a proposed removal of an identified item from a current item assortment for the retail environment; exemplary means for calculating a transference of demand between each item in the identified set of substitute items predicted to occur responsive to the proposed removal of the identified item, the transference of demand including a transference of at least a portion of demand from the identified item to at least one substitute item in the set of substitute items and a predicted walk-off rate associated with lost demand attributable to removal of the identified item; and exemplary means for generating a per-assortment demand transference result customized for the retail environment and the proposed item assortment based on the calculated demand transference and outputs the per-assortment demand transference result via a user interface component. The per-assortment demand transference result including an identification of each item in the set of substitute items predicted to receive at any portion of the demand transferred from the identified item and a magnitude of demand transferred to each item.

In another example, the elements illustrated in FIG. 1, FIG. 2, FIG. 3, FIG. 4, FIG. 5, FIG. 6, FIG. 7, and FIG. 8, such as when encoded to perform the operations illustrated in FIG. 13, FIG. 14, FIG. 15, and FIG. 16, constitute exemplary means for receiving a proposed item assortment including a set of items to be added to inventory associated with a retail environment and a set of items to be removed from inventory; exemplary means for analyzing transaction data associated with the retail environment, attribute data associated with the plurality of items, and assortment history data; exemplary means for calculating a demand transference between substitute items in a plurality of items associated with the proposed item assortment based on the analysis; exemplary means for generating a demand transference result score customized for the proposed item assortment generated based on the calculated demand transference by the demand prediction component. The transference result score includes an identification of each substitute item in the plurality of items predicted to experience an increase or decrease in demand due to an assortment change associated with the proposed item assortment and a magnitude of predicted demand change associated with each identified item.

In yet another example, the elements illustrated in FIG. 1, FIG. 2, FIG. 3, FIG. 4, FIG. 5, FIG. 6, FIG. 7, and FIG. 8, such as when encoded to perform the operations illustrated in FIG. 13, FIG. 14, FIG. 15, and FIG. 16, constitute exemplary means for receiving a proposed item assortment including at least one change to a current item assortment associated with a retail environment; exemplary means for calculating a demand transference between a set of substitute items associated with the proposed item assortment due to the at least one change, the at least one change including a proposed addition of a selected new item to a plurality of items available within the retail environment; exemplary means for generating a predicted demand transference result customized for the proposed item assortment based on the calculated demand transference, the demand transference result including an identification of each item in the set of items predicted to experience a change in demand due to addition of the selected new item to a current item assortment and a magnitude of the demand change associated with each item in the set of items; and exemplary means for outputting a recommendation to implement the proposed item assortment on condition the demand transference result indicates creation of new demand associated with the addition of the selected new item and predicted horizontal demand transference away from one or more legacy items to the selected new item is within an acceptable threshold range.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for demand transference modeling, the system comprising:
a memory;
at least one processor communicatively coupled to the memory;
a plurality of sensor devices associated with a retail environment;
an item selection component, implemented on the at least one processor, that analyzes attribute data for each item in a plurality of items, transaction data associated with the plurality of items during a predetermined time-period, and sensor data generated by the plurality of sensor devices to identify a set of substitute items for a proposed item assortment, the proposed item assortment comprising a proposed removal of an identified item from a current item assortment for the retail environment;
a demand transference modeling component, implemented on the at least one processor, that calculates a demand transference between each item in the identified set of substitute items predicted to occur responsive to the proposed removal of the identified item, the transference of the demand comprising a transference of at least a portion of the demand from the identified item to at least one substitute item in the set of substitute items and a predicted walk-off rate associated with lost demand attributable to removal of the identified item; and
a results component, implemented on the at least one processor, that generates a per-assortment demand transference result customized for the retail environment and the proposed item assortment based on the calculated demand transference and outputs the per-assortment demand transference result via a user interface component, the per-assortment demand transference result comprising an identification of each item in the set of substitute items predicted to receive at any portion of the demand transferred from the identified item and a magnitude of the demand transferred to each item.

2. The system of claim 1, wherein the walk-off rate associated with the identified item further comprises a lost demand score, the lost demand score quantifying lost sales associated with the removal of the identified item from inventory, and further comprising:
an assortment recommendation component, implemented on the at least one processor, that outputs an accept recommendation associated with the proposed item assortment recommending the removal of the identified item from the current item assortment for the retail environment on condition the lost demand score is within an acceptable threshold range, and wherein the assoi linent recommendation component outputs a reject recommendation recommending retaining the identified item within the current item assortment on condition the lost demand score falls outside the threshold range.

3. The system of claim 1, wherein the calculated demand transference comprises a transferred demand score, the transferred demand score quantifying the magnitude of demand transferred from the identified item to at least one substitute item in the proposed item assortment, and further comprising:
an assortment recommendation component, implemented on the at least one processor, that outputs an accept recommendation associated with the proposed item assortment recommending the removal of the identified item from the current item assortment on condition the transferred demand score is within a threshold range, and wherein the assortment recommendation component outputs a reject recommendation comprising a recommendation to retain the identified item within the current item assortment on condition the transferred demand score falls outside the threshold range.

4. The system of claim 1, wherein the proposed item assortment comprises a proposed new item to be added to the current item assortment for the retail environment, and further comprising:
the demand transference modeling component, implemented on the at least one processor, that calculates a demand transference away from at least one item in the plurality of items within the current item assortment to the proposed new item, wherein the per-assortment demand transference result further comprises an identification of the at least one item predicted to lose demand to the proposed new item and the magnitude of the demand transferred away from the at least one item to the proposed new item.

5. The system of claim 1, wherein the proposed item assortment comprises a proposed new item to be added to the current item assortment for the retail environment, and further comprising:
the demand transference modeling component, implemented on the at least one processor, that calculates a per-item incremental demand associated with the selected item on addition of the selected item to the proposed item assortment, wherein the per-assortment demand transference result further comprises an identification of a number of instances of the selected item predicted to be sold during a predetermined time-period on condition the selected item is added to inventory of a given retail store.

6. The system of claim 1, wherein the proposed item assortment is a first proposed item assortment, and the demand transference is a first demand transference, and further comprising:
the demand transference modeling component, implemented on the at least one processor, that calculates a second demand transference for a second proposed item assortment comprising a set of assortment changes, the set of assortment changes comprising at least one item to be added to the plurality of items and at least one item to be removed from the plurality of items, wherein the second demand transference is calculated based on an analysis of the transaction data and the attribute data associated with the plurality of items; and
the results component, implemented on the at least one processor, that generates a demand transference result customized for the proposed item assoi iment based on the calculated second demand transference, the demand transference result comprising an identification of each item in the plurality of items associated with a predicted change in demand due to the set of assoi linent changes.

7. The system of claim 1, further comprising:
a scoring component, implemented on the at least one processor, that calculates an item similarity score for each item in the set of substitute items in a first proposed item assortment, the item similarity score indicating a degree of similarity associated with at least one attribute of each item, wherein the scoring component calculates an updated item similarity score for each item in the plurality of items in a second proposed item assortment, wherein the item similarity score for a given item changes for each proposed item assortment, and wherein the demand transference modeling component utilizes the similarity score for substitute items in a given assortment using per-store item demand pattern data to generate the demand transference between items in the set of substitute items in the given assortment.

8. A computer-implemented method for demand transference modeling, the computer-implemented method comprising:
receiving, by a demand prediction component implemented on a processor, a proposed item assortment associated with a retail environment, the proposed item assortment comprising a set of items to be added to inventory and a set of items to be removed from the inventory;
calculating, by the demand prediction component, a demand transference between substitute items in a plurality of items associated with the proposed item assortment based on an analysis of transaction data associated with the retail environment, attribute data associated with the plurality of items, and assortment history data;
generating a demand transference result score customized for the proposed item assortment generated based on the calculated demand transference by the demand prediction component, the transference result score comprising an identification of each substitute item in the plurality of items predicted to experience an increase or decrease in demand due to an assortment change associated with the proposed item assortment and a magnitude of predicted demand change associated with each identified item.

9. The computer-implemented method of claim 8, further comprising:
calculating the demand transference from a first item to a second item in the plurality of items due to a proposed removal of the first item from the inventory and a predicted magnitude of lost demand associated with removal of the first item from the inventory.

10. The computer-implemented method of claim 8, further comprising:
calculating the demand transference from a first item to a second item in the plurality of items due to a proposed addition of the second item to the inventory and a predicted magnitude of new demand created by addition of the second item to the inventory.

11. The computer-implemented method of claim 8, further comprising:
calculating, by a scoring component, an item similarity score for each item in the plurality of items in a first proposed item assortment, the item similarity score indicating a degree of similarity associated with at least one attribute of each item, wherein the scoring component calculates an updated item similarity score for each item in the plurality of items in a second proposed item assortment, wherein the item similarity score for a given item changes for each proposed item assortment.

12. The computer-implemented method of claim 8, further comprising:
calculating a second demand transference for a second proposed item assortment, the second proposed item assortment comprising a second set of items to be added to the plurality of items and a second set of items to be removed from the plurality of items; and
outputting an updated demand transference result customized for the second proposed item assortment generated based on the calculated second demand transference, the updated demand transference result comprising the identification of each item in associated with a predicted change in demand due to the assortment change associated with the second proposed item assortment.

13. The computer-implemented method of claim 8, wherein the demand transference result comprises a predicted transfer of demand between substitute items due to a change in item assortment for a given retail store, and wherein the demand transference result varies based on each different combination of items in each different proposed item assortment.

14. A system for demand transference modeling between substitute items in an item assortment, the system comprising:
a memory;
at least one processor communicatively coupled to the memory;
a demand transference modeling component, implemented on the at least one processor, that receives a proposed item assortment comprising at least one change to a current item assortment associated with a retail environment and calculates a demand transference between a set of substitute items associated with the proposed item assortment due to the at least one change, the at least one change comprising a proposed addition of a selected new item to a plurality of items available within the retail environment;
a results component, implemented on the at least one processor, that generates a predicted demand transference result customized for the proposed item assortment generated based on the calculated demand transference, the demand transference result comprising an identification of each item in a set of items predicted to experience a change in demand due to addition of the selected new item to the current item assortment and a magnitude of the change in demand associated with each item in the set of items; and
an assortment recommendation component, implemented on the at least one processor, that outputs a recommendation to implement the proposed item assortment on condition the demand transference result indicates creation of new demand associated with the addition of the selected new item and predicted horizontal demand transference away from one or more legacy items to the selected new item is within an acceptable threshold range.

15. The system of claim 14, further comprising:
the assortment recommendation component, implemented on the at least one processor, that outputs the recommendation to reject the proposed item assortment on condition the demand transference result indicates a lack of new demand created by addition of the selected new item or predicted horizontal demand transference away from the one or more legacy items to the selected new item is outside the acceptable threshold range to prevent cannibalization of sales associated with the legacy items.

16. The system of claim 14, further comprising:
the demand transference modeling component, implemented on the at least one processor, that calculates a second demand transference for a second proposed item assortment, the second proposed item assortment comprising a proposed set of assortment changes, the proposed set of assortment changes comprising a set of items to be added to the plurality of items and a set of items to be removed from the plurality of items based on an analysis of transaction data and attribute data associated with the plurality of items; and
the results component, implemented on the at least one processor, that generates a demand transference result customized for the proposed item assoi linent generated based on the calculated second demand transference, the transference result comprising the identification of each item associated with a predicted change in demand due to the proposed set of assortment changes.

17. The system of claim 14, wherein the proposed item assortment further comprises a proposed removal of an item from the plurality of items available within the retail environment, wherein the transference result comprises the identification of each item in a set of items predicted to experience a change in demand due to removal of the item and a magnitude of the predicted demand transference between each item in the set of items due to the proposed removal of the item.

18. The system of claim 14, wherein the predicted demand transference result comprises a lost demand score indicating a magnitude of lost sales associated with the proposed item assortment, and further comprising:
the assortment recommendation component, implemented on the at least one processor, that generates an accept recommendation associated with the proposed item assortment on condition the lost demand score is within an acceptable threshold range, and wherein the assortment recommendation component outputs a reject recommendation recommending retaining the identified item within the current item assortment on condition the lost demand score falls outside the acceptable threshold range.

19. The system of claim 14, further comprising:
an item selection component, implemented on the at least one processor, that analyzes attribute data for each item in the plurality of items, transaction data associated with the plurality of items during a predetermined time-period, and sensor data generated by a plurality of sensor devices within the retail environment to identify a set of substitute items for a given proposed item assortment.

20. The system of claim 14, further comprising:
a scoring component, implemented on the at least one processor, that calculates an item similarity score for each item in the plurality of items in a first proposed item assortment, the item similarity score indicating a degree of similarity associated with at least one attribute of each item, wherein the scoring component calculates an updated item similarity score for each item in the plurality of items in a second proposed item assortment, wherein the item similarity score for a given item changes for each different proposed item assortment.
